(19) United States
(12) Patent Application Publication
(10) Pub. No.: US 2026/0225935 A1
(43) Pub. Date: Aug. 6, 2026

(54) PEN SHAPED HANDHELD APPARATUS FOR GENERATING A WATER FROM AN AMBIENT HUMID AIR

(71) Applicant: MAJMAAH UNIVERSITY, Riyadh (SA)

(72) Inventor: Ibrahim M. ALARIFI, Riyadh (SA)

(73) Assignee: MAJMAAH UNIVERSITY, Riyadh (SA)

(21) Appl. No.: 19/635,427

(22) Filed: Mar. 31, 2026

(51) Int. Cl. C02F 9/20; B01D 5/00

(52) U.S. Cl. CPC C02F 9/20; B01D 5/0042; B01D 5/009

(57) ABSTRACT

The present invention discloses pen shaped handheld apparatus for generating a water from an ambient humid air, said apparatus comprising of a pen housing; a plurality of airflow channels configured to receive and direct the ambient humid air inside the pen housing; a thermoelectric cooling unit positioned within the pen housing and positioned adjacent to a hydrophilic condensation mesh to establish a cooled condensation surface; a condensation chamber, comprising the hydrophilic condensation mesh thermally coupled to the thermoelectric cooling unit for capturing and condensing the ambient humid air; one or more humidity and temperature sensors communicatively coupled to a microcontroller unit, to detect ambient environmental conditions prior to activation of the thermoelectric cooling unit; a microcontroller unit (MCU) configured to control an operation of the Thermoelectric cooling unit based on inputs of the one or more humidity and temperature sensors; a micro water reservoir positioned below the hydrophilic condensation mesh and fluidly connected to the hydrophilic condensation mesh for collecting condensed water.

### FIELD OF THE INVENTION

The present disclosure relates generally to portable water generation devices and, more particularly, to a miniaturized atmospheric water generator integrated within a pen-sized housing for individual or field use.

### BACKGROUND OF THE INVENTION

Portable access to fresh water remains a significant challenge in emergency, outdoor, and low-resource environments. Conventional atmospheric water generators (AWGs) typically require large-scale assemblies or significant power input to operate. There exists a need for a compact, handheld apparatus capable of extracting small quantities of water from atmospheric humidity while maintaining portability and dual functionality, such as writing.

Atmospheric water generation technology generally demands bulky heat exchangers, compressors, and substantial electrical powe. These requirements have confined conventional AWGs to stationary installations in residential, commercial, or industrial settings, limiting their utility in mobile or resource-constrained scenarios. Alternatively, sorption-based AWGs utilize hygroscopic materials such as zeolites, silica gels, metal-organic frameworks, or specialized polymers to adsorb moisture from air. While these materials can function at smaller scales, efficient desorption of collected water typically still requires external heat sources or controlled environmental cycling. In their current forms, both cooling and sorption AWG solutions struggle to combine high water yield, low energy consumption, and portability within a handheld footprint.

Further, emerging personal-use devices have attempted to bridge this gap by integrating small-scale condensation or desiccant technologies into backpack- or tabletop-sized units. However, these devices often remain too heavy or power-intensive for true handheld use. In many cases, performance is further degraded in low-humidity conditions where available water vapor is limited, resulting in unreliable output and limited practical utility.

In addition to functional limitations, there exists an unmet need for multi-purpose devices that integrate utility with everyday tools. Items like pens are ubiquitous, carried by most individuals, and familiar in form factor. A handheld device that can generate potable water while doubling as a writing instrument would introduce substantial advantages in terms of user adoption, convenience, and emergency preparedness.

Because of limitations in power supply, size, thermal management, and material integration, there remains a significant gap in the art for a compact, low-power, mechanically simple apparatus capable of capturing, condensing, or otherwise extracting water from ambient humid air on-demand. Such a device would be particularly valuable in field conditions, humanitarian aid scenarios, survival kits, remote travel, and other environments where traditional sources of potable water are scarce or inaccessible.

The present invention addresses these challenges by providing a pen-shaped handheld apparatus and method for water generation that operates effectively in a variety of humidity conditions, requires minimal external power, and integrates seamlessly with a form factor familiar to users. This invention combines innovative components and methods to improve efficiency, portability, and usability compared to existing AWG systems.

### SUMMARY OF THE INVENTION

The present disclosure relates generally to portable water generation devices and, more particularly, to a miniaturized atmospheric water generator integrated within a pen-sized housing for individual or field use.

In an embodiment, a pen shaped handheld apparatus for generating a water from an ambient humid air, said apparatus comprising of a pen housing; a plurality of airflow channels configured to receive and direct the ambient humid air inside the pen housing; a thermoelectric cooling unit positioned within the pen housing and positioned adjacent to a hydrophilic condensation mesh to establish a cooled condensation surface; a condensation chamber, comprising the hydrophilic condensation mesh thermally coupled to the thermoelectric cooling unit for capturing and condensing the ambient humid air, wherein the thermoelectric cooling unit cools the ambient humid air below its dew point and condense onto the hydrophilic condensation mesh; one or more humidity and temperature sensors communicatively coupled to a microcontroller unit, wherein the one or more humidity and temperature sensors are positioned within and adjacent to the airflow channels and are configured to detect ambient environmental conditions prior to activation of the thermoelectric cooling unit; a microcontroller unit (MCU) configured to control an operation of the Thermoelectric cooling unit based on inputs of the one or more humidity and temperature sensors, wherein the MCU is configured to receive environmental data signals from the one or more humidity and temperature sensors for detecting ambient humidity and temperature; a micro water reservoir positioned below the hydrophilic condensation mesh and fluidly connected to the hydrophilic condensation mesh for collecting condensed water; and a rechargeable lithium battery electrically coupled to the MCU and the thermoelectric cooling unit to provide portable power.

In another embodiment, a method for generating a water from an ambient humid air, said apparatus comprising of initiating, by a microcontroller unit, one or more humidity and temperature sensors to detect ambient environmental conditions, wherein one or more humidity and temperature sensors communicatively coupled to the microcontroller unit, wherein the one or more humidity and temperature sensors are positioned within and adjacent to airflow channels; providing, by one or more humidity and temperature sensors, environmental data signals to the microcontroller unit (MCU) when the ambient air is humid air; receiving, by a plurality of airflow channels, and directing the ambient humid air inside the pen housing; providing, by a thermoelectric cooling unit, a cooled condensation surface, wherein the Thermoelectric cooling unit is positioned within the pen housing and positioned adjacent to a hydrophilic condensation mesh; capturing and condensing, by the hydrophilic condensation mesh thermally coupled to the Thermoelectric cooling unit, the ambient humid air, wherein the thermoelectric cooling unit cools the ambient humid air below its dew point and condense onto the hydrophilic condensation mesh; and collecting, by a micro water reservoir, collecting condensed water, wherein the micro water reservoir is positioned below the hydrophilic condensation mesh and fluidly connected to the hydrophilic condensation mesh.

Another objective of the present disclosure is to provide a controlled assembly enables both standard writing functions and on-demand micro-scale water production in a self-contained portable system.

Another objective of the present disclosure is to extract moisture from the atmosphere, condense the moisture on a hydrophilic surface, and store in a miniature internal reservoir.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a longitudinal cross-sectional view of the pen showing the arrangement of internal components in accordance with an embodiment of the present disclosure;

FIG. 2 illustrates an exploded view depicting individual components and their assembly alignment in accordance with an embodiment of the present disclosure;

FIG. 3 illustrates a system block diagram illustrating the logical interconnection between electronic elements and power flow in accordance with an embodiment of the present disclosure;

FIG. 4 illustrates a longitudinal cross-sectional view of the pen in accordance with an embodiment of the present disclosure;

FIG. 5 illustrates an implementation of the pen for water purpose in accordance with an embodiment of the present disclosure;

FIG. 6 illustrates an exploded view of the pen in accordance with an embodiment of the present disclosure;

FIG. 7 illustrates longitudinal cross sectional view of individual components of the pen in accordance with an embodiment of the present disclosure;

FIG. 8 illustrates longitudinal cross sectional view of the pen in accordance with an embodiment of the present disclosure;

FIG. 9 illustrates longitudinal cross sectional view of the pen in accordance with an embodiment of the present disclosure;

FIG. 10 illustrates CAD design of the pen in accordance with an embodiment of the present disclosure;

FIG. 11 illustrates a block diagram of pen shaped handheld apparatus for generating a water from an ambient humid air; and

FIG. 12 illustrates a flow chart for a method for generating water from an ambient humid air in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a method or method that comprises a list of steps does not include only those steps but may include other steps not expressly listed or inherent to such method or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

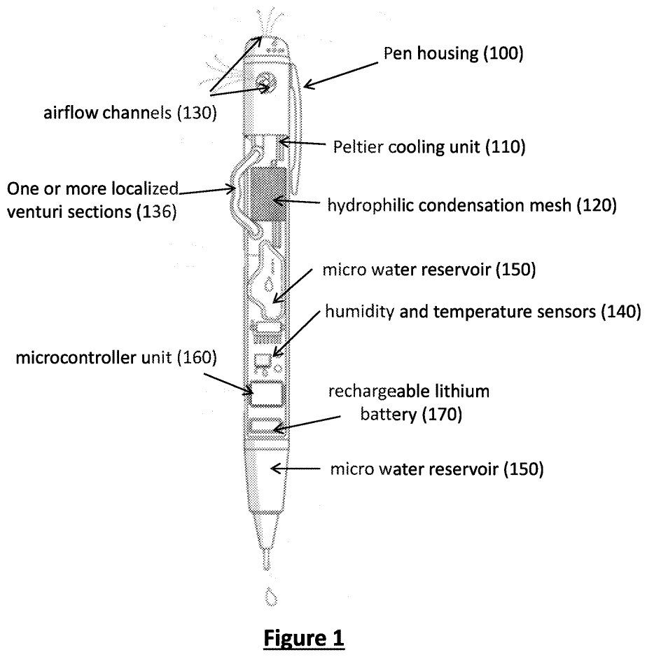

FIG. 1 illustrates a longitudinal cross-sectional view of the pen showing the arrangement of internal components in accordance with an embodiment of the present disclosure. Referring to FIG. 1, the pen housing (100) encloses all major functional modules. A Peltier cooling unit (110) is located near the mid section to create a thermal gradient. Its cooled side thermally interfaces with a hydrophilic condensation mesh (120) that facilitates droplet formation from ambient humidity drawn through airflow channels (130) positioned along the pen body.

One or more humidity and temperature sensors (140) provide continuous environmental measurement. The sensors feed data to the microcontroller unit (160), which dynamically adjusts power to the Peltier cooling unit (110). Condensed water drips into the micro water reservoir (150). The microcontroller unit (160) and rechargeable lithium battery (170) are aligned toward the rear of the pen to maintain ergonomic weight balance.

FIG. 1 illustrates a longitudinal cross-sectional view of a water-generating pen device according to one embodiment of the present invention. The device includes an elongated pen housing (100) that encloses and supports the system's internal components. The pen housing (100) defines airflow channels (130) configured to admit ambient, humid air into the device's interior. A thermoelectric cooling unit (110) is disposed within the pen housing (100) and positioned adjacent to a hydrophilic condensation mesh (120). During operation, the thermoelectric cooling unit (110) cools incoming air below its dew point, causing atmospheric moisture to condense onto the hydrophilic condensation mesh (120). The condensed moisture flows downward into a micro water reservoir (150) positioned below the condensation region. A rechargeable lithium battery (170) is disposed in a lower portion of the pen housing (100) and supplies electrical power to the thermoelectric cooling unit (110) and other electronic components. A microcontroller unit (160) is electrically coupled to the thermoelectric cooling unit (110) and controls the device's operation based on sensor inputs and stored logic.

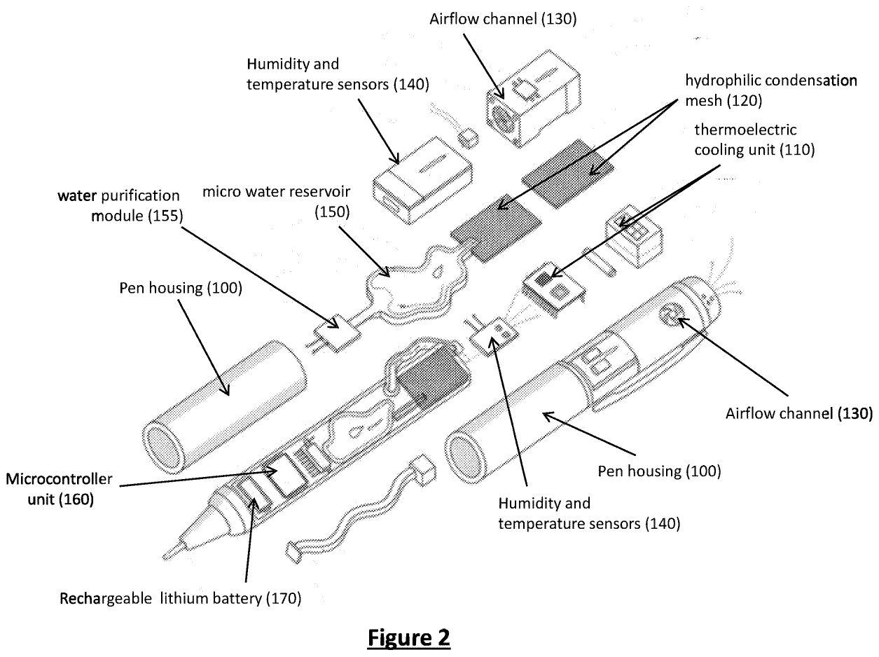

FIG. 2 illustrates an exploded view depicting individual components and their assembly alignment in accordance with an embodiment of the present disclosure. Referring to FIG. 2, the system may be assembled by inserting modular components along the pen's longitudinal axis. Each module cooling, control, energy, and reservoir is equipped with connectors to simplify maintenance and replacement.

FIG. 2 illustrates an exploded view of the water-generating pen device, showing the spatial relationships of the internal components along the longitudinal axis of the pen housing (100). The thermoelectric cooling unit (110) is shown separated from the hydrophilic condensation mesh (120) and the airflow channels (130), illustrating the modular construction of the condensation assembly. Humidity and temperature sensors (140) are positioned within or adjacent to the airflow channels (130) and are configured to detect ambient environmental conditions prior to activation of the thermoelectric cooling unit (110). The micro water reservoir (150) is shown disposed downstream of the condensation mesh (120) and upstream of a water purification module (155). The microcontroller unit (160) is illustrated as a discrete electronic control board operatively connected to the sensors (140), the thermoelectric cooling unit (110), and a power management circuit (165). The rechargeable lithium battery (170) is shown as a cylindrical power source removably or fixedly mounted within the pen housing (100). FIG. 2 further illustrates that the components are axially aligned to permit compact assembly within the pen housing (100).

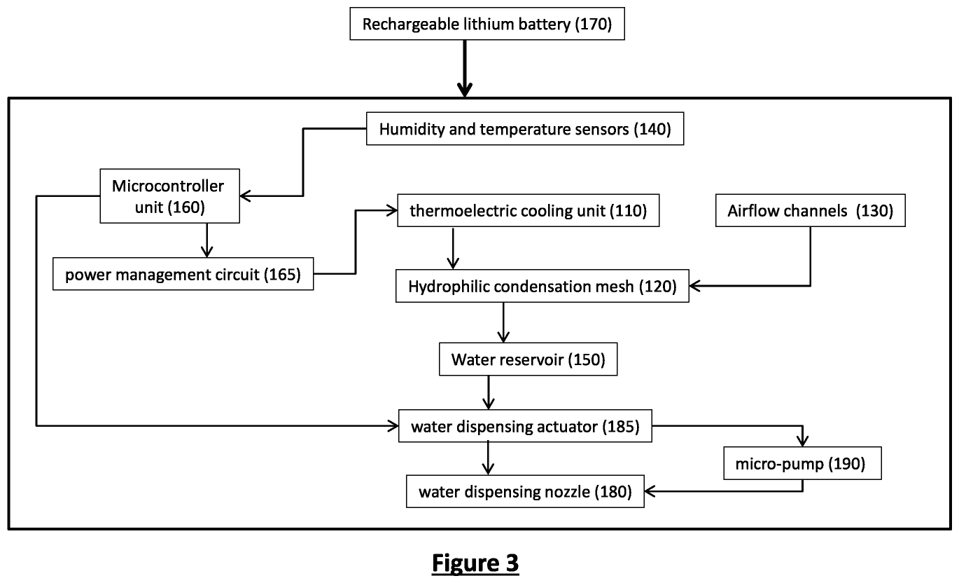

FIG. 3 illustrates a system block diagram illustrating the logical interconnection between electronic elements and power flow in accordance with an embodiment of the present disclosure. As shown in FIG. 3, the MCU manages inputs from the humidity sensors and outputs control signals to the Peltier unit. Power flow originates from the lithium battery (170), and the condensation yield is stored in the micro reservoir. Optional data logging or indicator systems may provide real-time operational status.

During operation, once the MCU determines that relative humidity exceeds a threshold, it activates the Peltier cooler to drive condensation. The process continues until the reservoir reaches capacity or ambient temperature limits efficiency. The collected water can be dispensed through a controlled outlet or used for micro applications such as ink rehydration.

FIG. 3 illustrates a functional block diagram of the water-generating pen device, depicting electronic and control relationships between components. Ambient humidity and temperature are detected by humidity and temperature sensors (140), which transmit environmental data signals to the microcontroller unit (160). Upon determining that atmospheric conditions are suitable for water generation, the microcontroller unit (160) activates the thermoelectric cooling unit (110) via the power management circuit (165). Electrical power is supplied to the microcontroller unit (160), thermoelectric cooling unit (110), and associated subsystems from the rechargeable lithium battery (170). The microcontroller unit (160) further controls the operation of a water dispensing actuator (185) and, in certain embodiments, a micro-pump (190) to selectively dispense water through a water dispensing nozzle (180).

FIG. 3 illustrates the closed-loop control architecture, in which sensor feedback, power regulation, and thermal control are coordinated to enable efficient atmospheric water generation and dispensing.

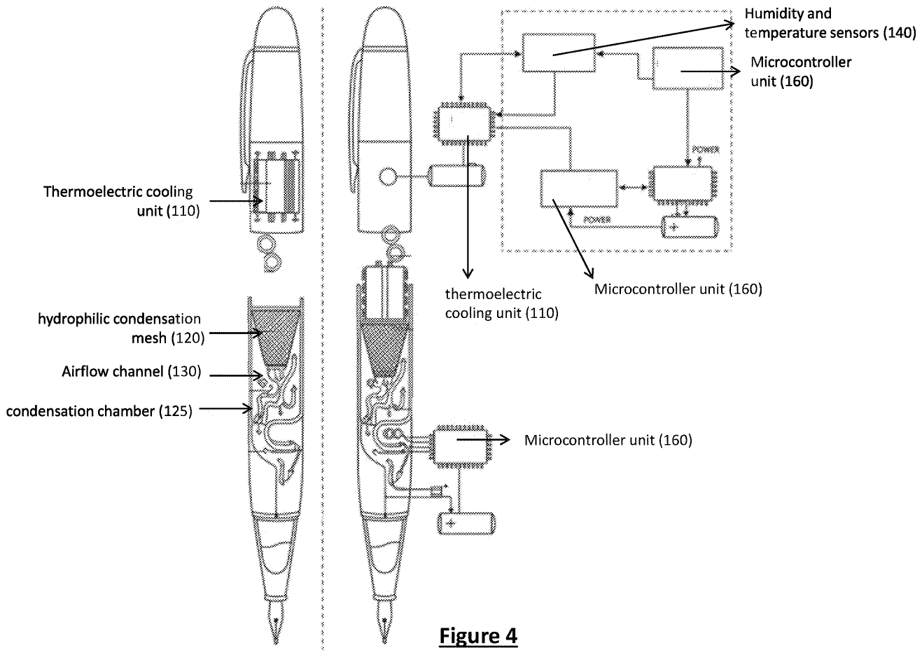

FIG. 4 illustrates a longitudinal cross-sectional view of the pen in accordance with an embodiment of the present disclosure. The device necessarily operates with a localized cold-junction temperature gradient, which enables dew-point crossing at the capture surfaces. Below is a thermodynamically consistent model that includes realistic AT values across the capture surfaces and clearly stated assumptions.

Localized Cold-Junction Gradient: A localized cold junction is formed at the interface between the thermoelectric cooling unit (110) and the hydrophilic condensation mesh (120). When the thermoelectric cooling unit (110) is energized, a temperature gradient is established between the cold junction adjacent to the condensation mesh (120) and the surrounding ambient air flowing through the airflow channels (130). This gradient is spatially localized within the condensation chamber (125) and is intentionally maintained to depress the air temperature below its dew point at the capture surface.

Because the condensation mesh (120) is thermally coupled to the cold side of the thermoelectric cooling unit (110) and simultaneously exposed to warmer, humid airflow, a continuous transverse temperature gradient exists across the capture surfaces during operation.

ΔT Across Capture Surfaces (Representative Values): Under typical operating conditions suitable for a pen-scale thermoelectric system, the following temperature differentials are implemented:
Ambient air temperature at intake: approximately 20-30° C.
Cold-junction surface temperature (mesh-adjacent): approximately 0-10° C.
Resulting localized temperature differential (ΔT): approximately ΔT≈10-25° C.

This ΔT is sufficient to drive the psychrometric process from unsaturated air to saturation and into condensation for a wide range of ambient humidity conditions (generally >40-50% RH).

Gradient Distribution Across the Capture Structure: The ΔT is not uniform across the entire condensation mesh (120) but instead exhibits a gradient profile:
The lowest temperature occurs at regions of the mesh (120) in direct thermal contact with the cold plate of the thermoelectric cooling unit (110).
Slightly higher temperatures occur toward the outer edges of the mesh (120) due to convective heat transfer from the incoming air stream.
This results in a localized cold-core/warm-boundary gradient, which promotes continuous droplet nucleation, coalescence, and downward flow.

In practice, the effective ΔT across the active condensation surface (mesh surface to adjacent airflow) is typically on the order of 5-15° C., even when the total cold-to-ambient ΔT is higher. This effective gradient is the one that directly governs the condensation rate.

Thermodynamic Interpretation (Psychrometric Context): From a psychrometric standpoint, the localized cold-junction gradient causes the air stream to undergo:
Sensible cooling as it approaches the cold capture surface
Dew-point crossing at the mesh-adjacent boundary layer
Latent heat rejection as water vapor condenses on the hydrophilic surface

The cold-junction gradient must therefore be sufficient not merely to reach the dew point but to maintain a sub-dew-point boundary layer despite continuous heat and mass transfer from incoming air.

During operation, a localized cold-junction temperature gradient is established between the thermoelectric cooling unit and the condensation surface, producing a temperature differential of approximately 10° C. to 25° C. relative to ambient air, thereby cooling the air in contact with the condensation surface below its dew point and inducing condensation of atmospheric moisture.

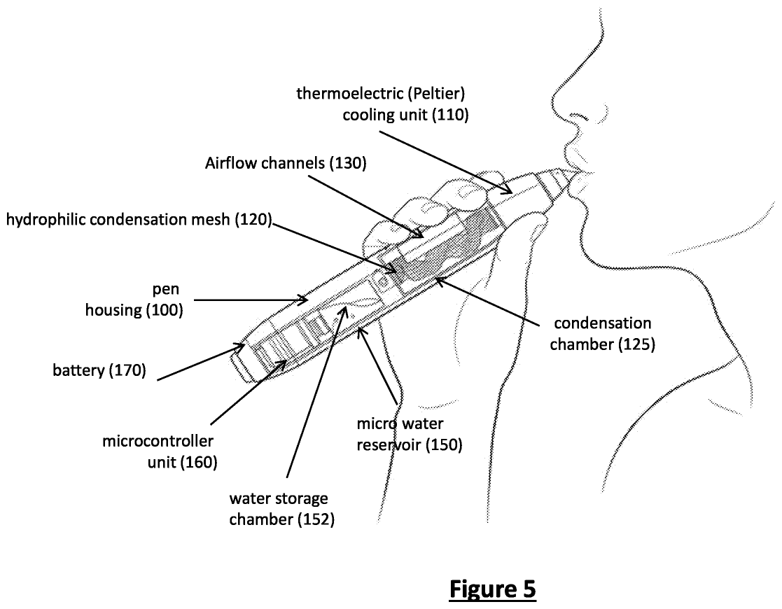

FIG. 5 illustrates an implementation of the pen for water purpose in accordance with an embodiment of the present disclosure. The device operates by actively lowering the temperature of ambient air below its dew point, causing water vapor to undergo a gas-to-liquid phase change directly on a cooled surface. This is the defining characteristic of a dew-point depression psychrometric cycle.

Inside the pen, ambient air enters through airflow channels (130) and is exposed to a cold surface generated by the thermoelectric (Peltier) cooling unit (110). When the air temperature is reduced below its saturation temperature at the given humidity ratio, water vapor condenses on the hydrophilic condensation mesh (120). The condensed liquid water is then collected and routed to the micro water reservoir (150).

From a psychrometric standpoint, the air undergoes:
Sensible cooling at (approximately) constant humidity ratio until reaching the dew point
Latent heat removal during condensation as moisture is removed from the air
A reduction in both dry-bulb temperature and humidity ratio

This is the classic cooling-dehumidification process, represented on a psychrometric chart by a leftward/downward trajectory that crosses the saturation curve—an active dew-point depression atmospheric water generation cycle using thermoelectric cooling and surface condensation.

Latent heat is rejected without raising the internal temperature of the pen barrel by combining directional heat flow, spatial thermal separation, transient heat spreading, and duty-cycled operation. The explanation below is written at a physics level.

When water vapor condenses on the hydrophilic condensation mesh (120), latent heat of vaporization is released at approximately 2,400 kJ/kg of condensed water. In a confined pen barrel, this heat must be continuously removed from the condensation region, or condensation will self-terminate due to local temperature rise. The device solves this by ensuring that latent heat never accumulates locally.

The thermoelectric cooling unit (110) does not merely cool the condensation surface; it actively pumps heat away from the cold junction toward a spatially separated hot junction. Latent heat released at the condensation mesh (120) is conducted into the cold plate of the thermoelectric cooling unit (110). It is immediately transported across the Peltier junction to the opposing hot side.

The pen housing (100) is internally partitioned-physically and thermally-into functional zones along its longitudinal axis. The condensation chamber (125) is thermally isolated from downstream components, such as the microcontroller unit (160), the battery (170), and the water storage chamber (152), by low-conductivity spacers and air gaps.

Latent heat rejected at the hot side of the thermoelectric cooling unit (110) is preferentially conducted toward a dedicated heat rejection region of the pen housing (100) rather than into the internal volume. This axial segregation prevents bulk internal temperature rise.

The hot junction of the thermoelectric cooling unit (110) is thermally coupled to heat dissipation elements that spread heat over a larger surface area of the pen housing (100). These elements may include thin internal heat spreaders, metallic shell coupling, or high-conductivity pathways embedded within the housing wall. Because the external surface area of the pen housing (100) is large relative to the power level involved, rejected latent heat is dissipated to the ambient environment through natural convection and radiation without perceptible temperature rise to the user. Importantly, the housing's thermal mass acts as a buffer, absorbing short-term heat spikes while maintaining stable internal temperatures.

At the pen scale, the absolute condensation rate is intentionally low (microliters per minute), meaning the instantaneous latent heat load is modest, typically on the order of hundreds of milliwatts. The microcontroller unit (160) further regulates operation by duty-cycling the thermoelectric cooling unit (110) based on sensor feedback from humidity and temperature sensors (140). This ensures that latent heat rejection never exceeds the thermoelectric system's and the housing's heat-removal capacity. When internal temperatures approach a threshold, condensation is temporarily halted until thermal equilibrium is restored.

At the condensation mesh (120) itself, latent heat is removed through a thin thermal boundary layer. The hydrophilic mesh promotes rapid droplet coalescence and drainage, minimizing the residence time of liquid water on the cold surface. This reduces thermal resistance and prevents localized hot spots that could otherwise raise surface temperature. Thus, latent heat is removed at the same spatial location and time scale as condensation occurs.

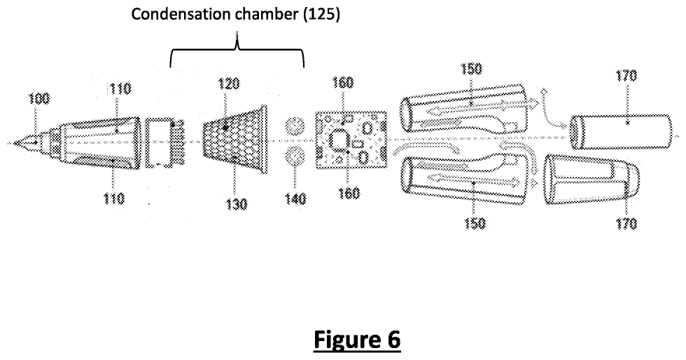

FIG. 6 illustrates an exploded view of the pen in accordance with an embodiment of the present disclosure. The airflow within the device is primarily laminarized rather than vortex-induced, with any secondary recirculation effects being weak, passive, and subordinate to laminar flow. Ambient air entering the pen housing (100) through the airflow channels (130) is constrained by the small hydraulic diameters and smooth internal geometries, which inherently suppress turbulence. The airflow is driven by natural convection and minor thermally induced pressure gradients generated by the thermoelectric cooling unit (110), resulting in low characteristic velocities. Under these conditions, the airflow remains within a low-Reynolds-number regime and is therefore laminarized by geometry, rather than actively mixed or swirled.

Within the condensation chamber (125), the airflow passes over and through the hydrophilic condensation mesh (120). The mesh structure further acts as a flow straightener and diffuser, breaking up any incipient velocity gradients and damping transverse momentum. This produces a stabilized laminar boundary layer adjacent to the condensation surface, which is advantageous for predictable heat and mass transfer and for maintaining a consistent sub-dew-point interface.

The device does not rely on deliberate vortex generation, swirl vanes, or turbulent eddies to increase residence time. Vortex-induced flow would increase pressure drop, promote droplet re-entrainment, and introduce thermal instability at the cold junction, all of which are undesirable at the pen scale. Instead, residence time is increased by low airflow velocity, extended surface contact length, and flow impedance created by the condensation mesh, rather than by recirculating vortices. Minor localized recirculation zones or micro-eddies may naturally arise downstream of mesh fibers or structural features due to geometric obstruction. These effects are incidental and highly damped, occurring at Reynolds numbers too low to produce sustained vortical flow. Such micro-scale disturbances do not constitute vortex-induced residence-time control and do not disrupt the overall laminar flow regime. The airflow within the device may be described as laminarized internal flow, wherein increased residence time is achieved through geometric confinement, low velocity, and distributed flow resistance, rather than through intentional vortex generation.

The device operates in steady-state condensation mode, with optional intermittent thermal cycling used only as a control and protection strategy, not as the primary water-generation mechanism. During normal operation, the device maintains the thermoelectric cooling unit (110) at a sub-dew-point temperature continuously for a defined operating interval. This creates a stable cold-junction temperature at the hydrophilic condensation mesh (120), allowing water vapor to condense continuously as long as ambient humidity conditions remain favorable.

In this mode, the psychrometric process is steady state. The temperature of the condensation surface, the humidity ratio of the adjacent air boundary layer, and the rate of latent heat removal reach a quasi-equilibrium. Condensation proceeds without requiring repeated heating and cooling of the capture surface. Water droplets nucleate, coalesce, and drain continuously into the micro water reservoir (150). This distinguishes the device from batch-type systems that rely on alternating capture and release phases.

Intermittent thermal cycling may be employed only at the system-control level, governed by the microcontroller unit (160), for reasons unrelated to moisture capture physics. Such cycling is used to manage battery consumption, prevent overheating, or respond to unfavorable environmental conditions.

For example, the microcontroller unit (160) may temporarily reduce or suspend power to the thermoelectric cooling unit (110) when humidity drops below a threshold, when internal temperatures approach a limit, or when battery charge is low. Once conditions recover, steady-state condensation is resumed. Critically, this intermittent cycling does not function as an adsorption-desorption or regeneration process. No moisture is stored and later released due to heating. Water is generated only during active cooling intervals.

Under steady-state operation, the effective moisture flux through the condensation capture interface can be expressed as a continuous mass-transfer process driven by the vapor density gradient between the ambient air and the cooled capture surface. Assuming typical operating conditions of approximately 25° C. ambient air temperature at about 60 percent relative humidity, the ambient water vapor density is on the order of 14 g/m³. When the condensation surface formed by the hydrophilic mesh is maintained at approximately 5° C., the saturated vapor density at the surface is reduced to about 6.8 g/m³, resulting in a vapor density difference of approximately 7.2 g/m³ across the boundary layer adjacent to the capture interface.

Relationship (Mass Transfer Form): The condensation mass flux can be approximated by:

$${\dot{m}}^{″} = {h}_{m} ( {ρ}_{v , ∞} - {ρ}_{v , s} )$$

where
\dot{m}″=moisture flux (kg/m²·s)
hₘ=mass-transfer coefficient
ρ_{v,∞}=vapor density of ambient air
ρ_{v,s}=vapor density at saturated cold surface
For small, cooled surfaces under low airflow, a representative effective mass-transfer coefficient is:

$${h}_{m} \approx 0.002 to 0.006 m / s$$

Under the low-velocity, laminar or mixed natural-convection airflow conditions characteristic of a pen-scale device without active forced ventilation, the effective mass-transfer coefficient between the air and the cooled surface is typically in the range of about 0.002 to 0.006 m/s. Applying this coefficient to the vapor density difference yields a condensation mass flux on the order of 0.014 to 0.043 g/m²·s. When expressed on an hourly basis, this corresponds to an effective moisture flux of approximately 50-150 g/m²·h through the condensation capture interface.

### Vapor Density Difference

At 25° C., 60% RH:
   Saturation vapor density at 25° C.≈23 g/m³
   Actual vapor density≈14 g/m³
   At 5° C. (surface, saturated):
   Saturation vapor density≈6.8 g/m³

$$Δ {ρ}_{v} \approx 14 - 6.8 = 7.2 g / {m}^{3}$$

This flux range is sufficient to support continuous, steady-state condensation at the small capture areas available within a pen-sized housing while maintaining manageable latent heat loads and stable thermal conditions. For purposes of technical description, the device therefore operates with an effective condensation interface moisture flux on the order of tens to low hundreds of grams per square meter per hour under typical ambient conditions and sub-dew-point surface temperatures.

### Calculated Moisture Flux

Using the conservative-to-moderate range of hₘ:

$${\dot{m}}^{″} = ( 0.002 to 0.006 ) \times 7.2$$

$${\dot{m}}^{″} \approx 0.014 to 0.043 g / {m}^{2} \cdot s$$

Converted to hourly units:

$${\dot{m}}^{″} \approx 50 to 155 g / {m}^{2} \cdot h$$

The effective moisture flux through the condensation capture interface is approximately 50-150 g/m²·h under typical ambient conditions (≈25° C., 60% RH) with a condensation surface maintained ~10-12° C. below the dew point.

The moisture capture surface is implemented as a hierarchical, hydrophilic structure with a broad pore-size distribution spanning the nanometer-to-micrometer scale, rather than a single, monodisperse pore size. In representative embodiments, the effective pore size distribution extends from approximately 50-200 nm at the lower bound to approximately 10-50 μm at the upper bound, with the majority of active condensation occurring within an intermediate range.

At the nanoscale, pores and surface features on the order of tens to several hundreds of nanometers arise from surface roughness, coatings, or fibrous microstructures. These nanoscale features promote heterogeneous nucleation by locally reducing the energy barrier for droplet formation when the surface is held below the dew point. While these pores do not store bulk liquid, they significantly increase the effective surface energy and nucleation site density, thereby enhancing the onset of initial condensation.

At the microscale, interconnected pores and interstitial gaps typically range from 1-20 μm, with some embodiments extending to 30-50 μm. This microscale pore regime governs droplet growth, coalescence, and capillary transport. Pores in this size range are large enough to allow rapid drainage of condensed liquid under capillary and gravitational forces, preventing surface flooding while maintaining continuous exposure of fresh, cold surface area to incoming humid air. The resulting pore size distribution is therefore intentionally multimodal, with nanoscale features supporting nucleation and microscale features supporting liquid transport and removal. From a functional standpoint, the moisture-capture surface behaves as a capillary-active, non-sorptive condensation medium rather than a hygroscopic adsorbent. For characterization, the capture surface may be described as having a pore size distribution spanning sub-micron (≈10² nm) to tens of microns, optimized to simultaneously promote condensation initiation, droplet coalescence, and efficient liquid drainage under steady-state dew-point depression operation.

In an embodiment, the BET-specific surface area of the hydrophilic condensation mesh is relatively low, typically on the order of 0.5-5 m²/g, and more commonly about 1-3 m²/g, depending on fiber diameter, surface roughness, and any thin hydrophilic coating applied. This surface area is dominated by external surface and open porosity rather than internal nanoporous volume. Because the capture surface operates via direct condensation rather than vapor adsorption, its water vapor sorption behavior follows a Type II isotherm according to the IUPAC classification. At low relative humidity, only a small amount of water is weakly adsorbed as a monolayer on hydrophilic surface sites. As relative humidity increases, multilayer adsorption occurs gradually without a sharp uptake step, and there is no distinct capillary condensation knee associated with microporous or mesoporous sorbents. Near saturation, the apparent uptake increases rapidly, not due to true adsorption into pores, but because of surface condensation and liquid film formation, which is reversible upon removal of the sub-dew-point condition.

Importantly, the isotherm exhibits minimal hysteresis when measured under conditions that avoid bulk condensation, further distinguishing the surface from hygroscopic or adsorbent materials such as silica gel, zeolites, or MOFs. Once the surface temperature rises above the dew point, condensed water drains or evaporates rather than remaining bound within the structure. From a functional and FIGs perspective, the capture surface is therefore characterized as having a low specific surface area relative to sorption media and a non-adsorptive, Type II water vapor sorption isotherm, with water collection governed by phase-change condensation rather than equilibrium vapor uptake. This distinction is important to separate the disclosed device from adsorption-desorption atmospheric water generators and to clarify that water accumulation occurs only during active dew-point depression operation.

In another embodiment, the capture medium is functionally graded along the airflow path, although the grading is passive and structural rather than actively controlled. As ambient air passes through the condensation chamber, the capture medium exhibits a deliberate longitudinal variation in thermal coupling, surface morphology, and effective pore-scale properties. Upstream regions of the capture medium, which first encounter the incoming humid air, are characterized by relatively finer surface features and a higher effective surface energy. This promotes early nucleation of condensed droplets as the air temperature is first depressed toward the dew point. These upstream regions are typically more tightly thermally coupled to the cold junction of the thermoelectric cooling unit, resulting in lower local surface temperatures and higher nucleation site density.

Downstream along the airflow path, the capture medium transitions to comparatively coarser microstructural features and larger effective pore or interstitial dimensions. This downstream grading favors droplet growth, coalescence, and rapid liquid transport away from the active condensation interface. The thermal coupling in these regions may be slightly reduced, producing a modest axial temperature rise that discourages re-entrainment of liquid droplets into the airflow while remaining below the local dew point.

Functionally, this grading causes the air stream to undergo progressive condensation, with vapor nucleation preferentially upstream and liquid collection and downstream drainage. The result is a stabilized condensation front, reduced surface flooding, and sustained exposure of cold surface area without choking or thermal short-circuiting.

From a characterization standpoint, the capture medium may therefore be described as functionally graded along the airflow direction with respect to surface energy, effective pore size, and thermal coupling, such that different longitudinal regions preferentially support nucleation, coalescence, and liquid removal while operating within a single steady-state dew-point depression regime.

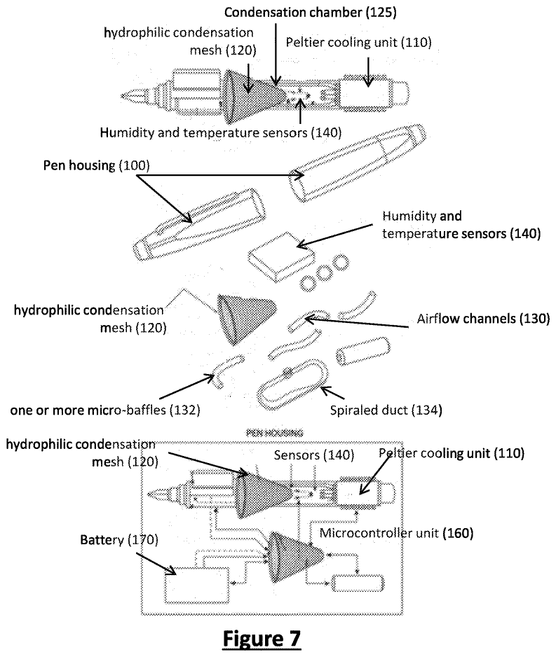

FIG. 7 illustrates longitudinal cross sectional view of individual components of the pen in accordance with an embodiment of the present disclosure. The airflow management features within the pen-shaped device may include one or more passive flow-conditioning structures, such as micro-baffles, helical duct segments, and localized Venturi sections, which are integrated into the airflow channels (130) and condensation chamber (125) to regulate residence time and boundary-layer behavior while preserving a laminar flow regime.

In certain embodiments, one or more micro-baffles (132) are formed as shallow internal ribs or transverse protrusions extending partially across the airflow channels (130). These micro-baffles (132) do not fully obstruct the airflow but instead act to redistribute velocity and damp axial momentum locally. The micro-baffles (132) increase effective flow path length and promote repeated renewal of the thermal and concentration boundary layers adjacent to the hydrophilic condensation mesh (120) without inducing turbulent flow. Due to the low Reynolds number of the airflow, the micro-baffles function as laminar flow resistors rather than vortex generators, thereby increasing residence time while maintaining predictable heat and mass transfer.

In some embodiments, portions of the airflow channels (130) are configured as a helical or gently spiraled duct (134) extending along a longitudinal axis of the pen housing (100). The helical duct (134) introduces a slow, controlled angular component to the airflow, causing the air to follow an elongated, curved path around the condensation chamber (125). This geometry increases the effective contact length between the air stream and the cooled condensation surfaces without creating sustained vortices. At the operating Reynolds numbers, the helical duct (134) produces a quasi-laminar, secondary flow that enhances exposure of the air stream to the cold junction while avoiding droplet re-entrainment.

Additionally, as shown schematically in FIG. 1, one or more localized Venturi sections (136) may be incorporated into the airflow channels (130) upstream or downstream of the condensation mesh (120). Each Venturi section (136) comprises a gradual constriction followed by a gradual expansion, resulting in a localized increase in air velocity and a corresponding reduction in static pressure. This pressure reduction helps draw ambient air through the condensation chamber (125) and maintain a consistent airflow rate under natural convection conditions. The Venturi sections (136) are dimensioned such that the resulting Reynolds number remains within the laminar regime, and no turbulent jetting occurs. Functionally, the micro-baffles (132), helical duct (134), and Venturi sections (136) cooperate to shape the airflow profile by increasing residence time, stabilizing laminar boundary layers, and promoting uniform exposure of humid air to the condensation surfaces.

As depicted in FIG. 3, these structures operate passively and require no active control or moving components, thereby preserving low power consumption and thermal stability.

For purposes of the characterization, the device may therefore be described as incorporating integrated passive flow-conditioning features, including micro-baffles, helical airflow paths, and localized Venturi geometries, which collectively regulate airflow velocity and residence time within the pen housing (100) while maintaining laminar internal flow across the condensation chamber (125).

At the condensation interface, the primary capture surface is predominantly hydrophilic, which promotes droplet nucleation, adhesion, and early-stage growth when the surface is maintained below the dew point. This hydrophilic character reduces the contact angle of condensed water, encouraging droplets to spread and coalesce rather than remain as isolated microdroplets that could be re-entrained into the airflow. The hydrophilic regions are thermally coupled to the cold junction so that condensation preferentially initiates and persists at these locations.

Adjacent to, or downstream from, these hydrophilic regions, the surface chemistry and/or microtexture transitions to relatively hydrophobic boundary regions. These hydrophobic zones exhibit higher contact angles and lower surface adhesion, which discourage liquid retention and promote the directional movement of condensed water once droplets reach a critical size. The resulting surface-energy gradient causes liquid water to migrate away from the active condensation interface toward drainage pathways under the combined influence of capillary forces and gravity.

This hydrophilic-to-hydrophobic patterning may be implemented axially along the airflow path, laterally across the capture mesh, or through layered or coated structures. In all cases, the boundary layers separate the functions of condensation and transport, ensuring that the fresh, cold surface remains exposed to humid air while collected water is efficiently removed. The boundary layers are static and passive, requiring no actuation or switching, and they operate continuously during steady-state condensation.

From a functional standpoint, the engineered contrast in wettability establishes a preferred condensate flow direction, minimizes surface flooding, reduces thermal resistance at the cold junction, and stabilizes the condensation front. For this purpose, the capture medium can therefore be described as incorporating engineered hydrophilic regions for vapor condensation and hydrophobic regions for condensate shedding and directional transport, forming an integrated boundary-layer system that passively directs liquid water away from the capture interface.

Capillary breakthrough pressure in the device is intentionally tuned through geometric, surface-energy, and structural parameters of the capture medium, rather than through active valves or pressure regulation. The tuning ensures that condensed water is retained long enough to coalesce and then released in a controlled manner toward drainage paths without flooding the condensation interface.

At a fundamental level, the breakthrough pressure is governed by the Young-Laplace equation, which relates capillary pressure to the effective pore radius, surface tension, and wettability. In the capture medium, this relationship is exploited by selecting and grading pore dimensions, surface chemistry, and layer thickness along the airflow and drainage directions.

The primary tuning mechanism is control of effective pore size and pore throat geometry. Upstream regions of the capture surface incorporate smaller pore throats or tighter interstitial gaps, typically in the sub-micron to low-micron range, which produce higher capillary pressures. This elevated breakthrough pressure prevents premature liquid penetration and ensures that condensed droplets remain pinned to the cold surface until sufficient coalescence occurs. Downstream regions transition to larger pore sizes, which lowers the local capillary pressure threshold and allows liquid water to break through and drain once a critical volume is reached.

A second tuning mechanism is wettability patterning, achieved by engineering hydrophilic and hydrophobic regions. Hydrophilic areas exhibit low contact angles, increasing capillary retention pressure, and stabilizing liquid films at the condensation interface. Hydrophobic boundary layers or drainage zones increase the effective contact angle, thereby reducing capillary pressure and facilitating breakthrough and release of liquid water. The spatial transition in surface energy creates a controlled capillary pressure gradient that directs condensate flow.

A third mechanism involves layer thickness and stacking architecture. Thin capture layers in direct thermal contact with the cold junction minimize hydrostatic head and maintain high effective capillary pressure. In contrast, thicker or more open downstream layers tolerate liquid accumulation and promote gravity-assisted drainage. By adjusting the thickness and compression of fibrous or mesh layers during assembly, the breakthrough pressure can be finely adjusted without changing materials.

Thermal coupling also plays a secondary role. Regions with stronger thermal coupling remain colder, sustaining higher surface tension and lower vapor pressure at the liquid interface, which indirectly stabilizes capillary retention. Slightly warmer downstream regions reduce liquid viscosity and surface tension, lowering the effective breakthrough threshold and encouraging release.

In combination, these design choices allow the capillary breakthrough pressure to be set high enough to prevent flooding and re-entrainment at the condensation surface, yet low enough to permit reliable drainage under steady-state operation. For characterization, the system may be described as tuning capillary breakthrough pressure by selectively controlling pore size, wettability, and structural layering, thereby passively regulating when and where condensed liquid transitions from retention to transport within the device.

The condensation chamber (125) and downstream liquid transport paths are configured with monotonically draining geometries that avoid closed cavities, dead-end pockets, or upward-facing concave surfaces in which gas bubbles could be retained. Liquid pathways are sloped or tapered toward the micro water reservoir (150), ensuring that any entrained gas is displaced downstream rather than trapped within the structure.

The hydrophilic condensation mesh (120) plays a primary role in bubble suppression. Once condensation begins, liquid water preferentially wets the mesh fibers and internal surfaces, forming a continuous liquid film or connected droplet network. This wetting behavior eliminates isolated liquid plugs and prevents the formation of capillary-sealed chambers that could trap gas. Because the mesh pores are small and wetted, any residual gas is forced to migrate through larger upstream vapor pathways rather than remaining enclosed within the liquid phase.

Capillary pressure gradients are also engineered to discourage bubble stabilization. The condensation mesh (120) and associated drainage layers exhibit directionally graded pore sizes, with smaller pores upstream and larger pores downstream. This configuration produces higher capillary pressure at the condensation interface and lower capillary pressure toward the drainage region. Any gas bubble attempting to remain trapped within the liquid encounters an unfavorable pressure gradient that drives it toward the vapor side, where it rejoins the airflow rather than remaining embedded in the liquid.

Thermal gradients further assist in bubble removal. The coldest regions are located at the condensation interface, while downstream drainage regions are slightly warmer. Any gas bubble near the cold surface continues to condense at its boundary, causing it to shrink rather than persist. This thermal “collapse” effect prevents long-term bubble retention at the capture interface and promotes continuous liquid continuity.

In addition, the system avoids pulsed condensation or rapid thermal cycling, which are common causes of bubble nucleation and entrapment in microfluidic systems. Because condensation proceeds under steady-state conditions, there are no abrupt phase transitions or pressure reversals that could introduce or stabilize trapped gas volumes.

Importantly, the device does not rely on active degassing, mechanical venting valves, or gas-permeable membranes. Bubble prevention is achieved entirely through open drainage geometry, hydrophilic surface energy, capillary pressure gradients, and steady thermal operation.

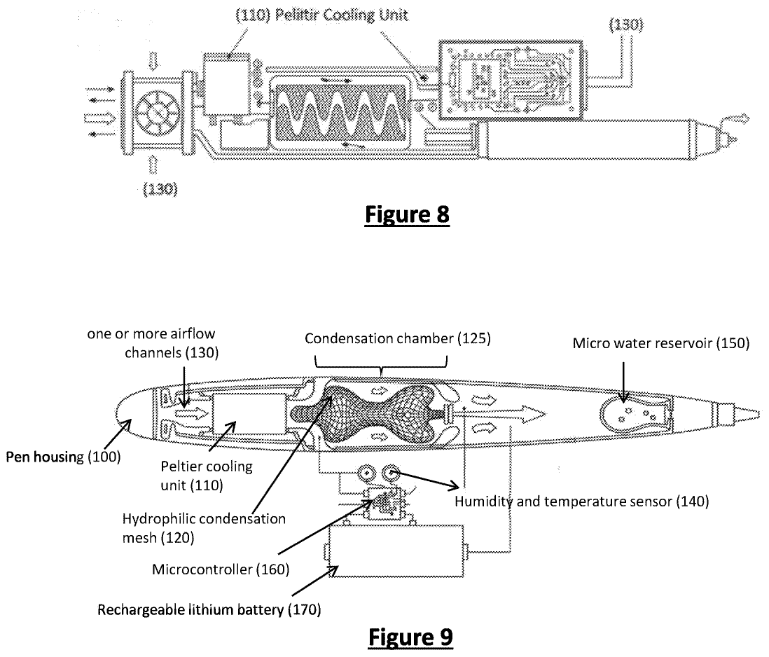

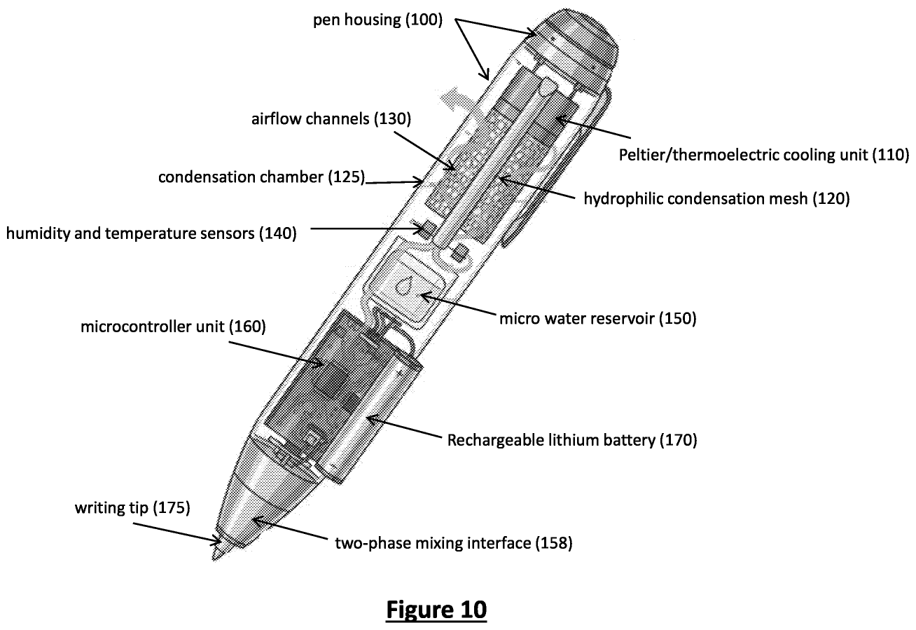

FIG. 8 illustrates longitudinal cross sectional view of the pen in accordance with an embodiment of the present disclosure. FIG. 9 illustrates longitudinal cross sectional view of the pen in accordance with an embodiment of the present disclosure. The airflow regime within the pen-shaped device operates in a low-Reynolds-number laminar flow regime. Ambient air enters the device through one or more airflow channels (130) formed within the pen housing (100). It is directed toward the condensation chamber (125), which contains the hydrophilic condensation mesh (120). The airflow channels (130) have small hydraulic diameters, typically on the order of fractions of a millimeter to a few millimeters, consistent with the device's overall pen-scale geometry. Airflow is driven by natural convection, weak buoyancy effects, or minimal pressure differentials induced by thermal gradients, rather than by an active fan.

Under representative operating conditions, the characteristic air velocity within the airflow channels (130) is approximately 0.01 to 0.1 m/s. Using air properties at room temperature and pressure, and taking a representative hydraulic diameter of approximately 0.5 to 2.0 mm for the airflow channels (130), the resulting Reynolds number, defined as

Re=(ρ·v·Dₕ)/μ,

falls well below the conventional laminar-turbulent transition threshold.

More specifically, the Reynolds number in the airflow channels (130) is typically on the order of Re≈1-100, and in many embodiments, Re<50, indicating fully laminar flow. Even within the condensation chamber (125), where airflow expands slightly around the condensation mesh (120), the Reynolds number remains in the laminar regime due to the low velocities and short characteristic length scales.

This laminar airflow regime is intentionally maintained to promote stable thermal and mass-transfer boundary layers at the condensation surface. Laminar flow minimizes turbulent mixing, reduces re-entrainment of condensed droplets, and allows predictable vapor diffusion toward the cold capture interface. The microcontroller unit (160) does not actively regulate airflow velocity. Instead, it relies on the geometric constraints of the pen housing (100) and the low-power thermal operation of the thermoelectric cooling unit (110) to preserve this low-Reynolds-number regime during steady-state condensation. Accordingly, for purposes of description and claim interpretation, the airflow within the pen-shaped atmospheric water generation device may be characterized as laminar internal flow operating at Reynolds numbers substantially below 2,000, and more particularly below approximately 100, throughout the airflow channels (130) and condensation chamber (125).

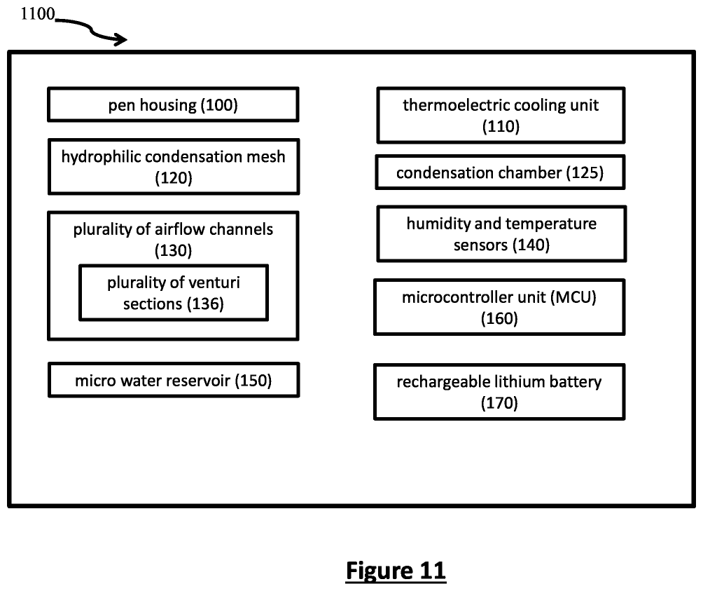

FIG. 10 illustrates CAD design of the pen in accordance with an embodiment of the present disclosure. The system includes a passive two-phase mixing interface upstream of the writing nib, whereas pure-condensate embodiments omit such an interface. The distinction is structural and intentional.

In an embodiment, a two-phase mixing interface (158) is disposed between the micro water reservoir (150) and the writing tip (175). At this interface, a liquid water phase derived from atmospheric condensation is brought into controlled contact with a concentrated or semi-solid ink phase contained within an ink reservoir or ink-impregnated medium. The interface is formed by a porous, fibrous, or gel-like structure that supports simultaneous coexistence of two phases—free or weakly bound condensate and ink constituents—without requiring active agitation or pumping.

Mixing at the two-phase interface occurs via capillary wicking, diffusion, and partial solubilization rather than bulk blending. The geometry and wettability of the interface limit the rate at which condensate penetrates the ink medium, thereby producing a stabilized, homogeneous writing fluid before it reaches the nib (175). Importantly, the interface remains upstream of the nib so that only a single-phase, viscosity-conditioned fluid is delivered to the writing tip during use.

The two-phase mixing interface (158) also functions as a buffering region that smooths temporal variations in condensate generation rate and purity. Any localized excess of water is absorbed and equilibrated within the ink medium before downstream transport, preventing transient flooding or dilution at the nib.

In contrast, in embodiments where the writing fluid is pure condensate, no two-phase mixing interface is required. In such configurations, the micro water reservoir (150) is directly fluidically coupled to the writing tip (175) via a capillary transport element, and the system remains single-phase throughout the fluid path.

The device employs an active, localized dew-point suppression mechanism based on thermoelectric cooling, rather than chemical, sorptive, or pressure-based suppression. Dew-point suppression is achieved by the thermoelectric cooling unit (110) disposed within the pen housing (100) and thermally coupled to the condensation chamber (125) and the hydrophilic condensation mesh (120). When energized, the thermoelectric cooling unit (110) establishes a temperature differential across its junctions, thereby actively reducing the temperature of the cold-side surface in contact with the condensation mesh (120). This localized reduction in surface temperature lowers the air temperature in the immediate boundary layer adjacent to the mesh below the dew point corresponding to the ambient humidity of the incoming air.

Importantly, the device does not alter the bulk humidity or pressure of the incoming air to suppress the dew point. Instead, the air's dew point remains fixed by ambient conditions, and condensation is induced by actively lowering the local air temperature below that dew point at the capture interface. This constitutes a direct dew-point depression mechanism, also referred to as cooling-based psychrometric suppression.

The condensation mesh (120) is positioned to maximize thermal coupling to the cold junction of the thermoelectric cooling unit (110) while remaining exposed to the airflow channels (130). This configuration ensures that dew-point suppression occurs in a thin, localized boundary layer at the surface of the mesh rather than throughout the pen's internal air volume. The result is efficient condensation with minimal cooling of non-participating air or internal components.

The thermoelectric cooling unit (110) is operated by the microcontroller unit (160) based on signals from humidity and temperature sensors (140). This control maintains the condensation surface at a temperature sufficiently below the ambient dew point to sustain steady-state condensation while avoiding unnecessary energy expenditure. The dew-point suppression is therefore actively controlled but spatially localized. The mechanism does not involve adsorption-desorption cycles, hygroscopic materials, phase-change storage media, pressure reduction, or evaporative cooling. Nor does it rely on intermittent reheating to release water. Condensation occurs only while the condensation surface is maintained below the dew point, and collected water is removed in liquid form.

Accordingly, for purposes of specification and claim interpretation, the device may be characterized as employing an active, thermoelectrically driven dew-point depression mechanism, wherein atmospheric air is locally cooled below its dew point at a condensation surface to induce direct phase-change condensation.

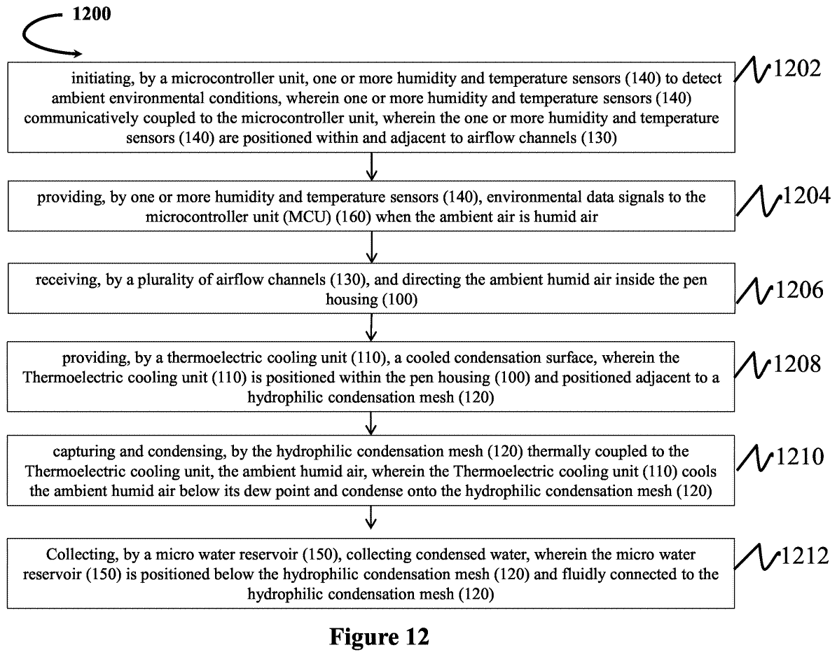

FIG. 11 illustrates a block diagram of pen shaped handheld apparatus for generating a water from an ambient humid air. The apparatus (1100) comprises: a pen housing (100); a plurality of airflow channels (130) configured to receive and direct the ambient humid air inside the pen housing (100); a thermoelectric cooling unit (110) positioned within the pen housing (100) and positioned adjacent to a hydrophilic condensation mesh (120) to establish a cooled condensation surface; a condensation chamber (125), comprising the hydrophilic condensation mesh (120) thermally coupled to the thermoelectric cooling unit for capturing and condensing the ambient humid air, wherein the thermoelectric cooling unit (110) cools the ambient humid air below its dew point and condense onto the hydrophilic condensation mesh (120); a one or more humidity and temperature sensors (140) communicatively coupled to a microcontroller unit, wherein the one or more humidity and temperature sensors (140) are positioned within and adjacent to the airflow channels (130) and are configured to detect ambient environmental conditions prior to activation of the thermoelectric cooling unit (110); a microcontroller unit (MCU) (160) configured to control an operation of the thermoelectric cooling unit based on inputs of the one or more humidity and temperature sensors (140), wherein the MCU (160) is configured to receive environmental data signals from the one or more humidity and temperature sensors (140) for detecting ambient humidity and temperature; a micro water reservoir (150) positioned below the hydrophilic condensation mesh (120) and fluidly connected to the hydrophilic condensation mesh (120) for collecting condensed water; and a rechargeable lithium battery (170) electrically coupled to the MCU and thermoelectric cooling unit to provide portable power, wherein the microcontroller unit (160) is configured to dynamically adjust an electrical power supplied to the thermoelectric cooling unit (110) in response to changes in sensed ambient humidity and temperature such that a difference between a vapor density of incoming air and a saturation vapor density at the hydrophilic condensation mesh (120) remains within a predefined operating range; wherein the thermoelectric cooling unit (110) is configured to extract heat from the hydrophilic condensation mesh (120) at a rate corresponding to a latent heat of condensation associated with water vapor transitioning from a gaseous phase to a liquid phase at the cooled condensation surface of the hydrophilic condensation mesh (120), such that a temperature of the hydrophilic condensation mesh (120) remains substantially constant during continuous condensation; and wherein the airflow channels (130) are configured such that a velocity of airflow produces a convective heat transfer coefficient that, in combination with conductive heat removal through the thermoelectric cooling unit (110), maintains a stable temperature gradient across the hydrophilic condensation mesh (120) during operation; and wherein the hydrophilic condensation mesh (120) is configured such that condensation occurs under a diffusion-limited regime in which a rate of water vapor transport toward the cooled condensation surface of the hydrophilic condensation mesh (120) is governed by a concentration gradient established between bulk airflow and a boundary layer adjacent to the hydrophilic condensation mesh (120); wherein the microcontroller unit (160) is configured to control operation of the thermoelectric cooling unit (110) based on a calculated difference between an enthalpy of incoming air and an enthalpy of air at the hydrophilic condensation mesh (120), such that energy removal corresponds to a combined sensible and latent heat reduction required for condensation; and wherein the thermoelectric cooling unit (110) and the hydrophilic condensation mesh (120) are configured such that a local heat flux from the hydrophilic condensation mesh (120) to the thermoelectric cooling unit (110) is proportional to a temperature difference between the cooled condensation surface of the hydrophilic condensation mesh (120) and a cold junction of the thermoelectric cooling unit (110), and wherein the local heat flux corresponds to heat released during condensation of water vapor.

In an embodiment, the pen shaped handheld apparatus (1100) further comprises: a plurality of venturi sections (136) incorporated into an airflow channels (130) upstream or downstream of the hydrophilic condensation mesh (120), wherein the plurality of venturi sections (136) comprise a converging cone and a diverging cone, configured to increase velocity of the air and decrease a static pressure of the air, wherein a static pressure reduction configured to draw ambient air through a condensation chamber (125) and maintain a consistent airflow rate under natural convection conditions; and a localized cold junction formed at an interface between the thermoelectric cooling unit (110) and the hydrophilic condensation mesh (120), wherein when the thermoelectric cooling unit (110) is energized, a temperature gradient is established between the cold junction adjacent to the hydrophilic condensation mesh (120) and a surrounding ambient air flowing through the airflow channels (130), configured to produce a temperature differential of approximately 10° C. to 25° C. relative to the ambient humid air, thereby cooling the air in contact with the cooled condensation surface below its dew point and inducing condensation of atmospheric moisture.

In an embodiment, a localized cold junction causes the air stream to undergo sensible cooling as it approaches a cold capture surface, dew-point crossing at a mesh-adjacent boundary layer and latent heat rejection as water vapor condenses on a hydrophilic surface, wherein the stable temperature gradient is spatially localized within the condensation chamber (125) and is intentionally maintained to depress an air temperature below its dew point at a capture surface, wherein the hydrophilic condensation mesh (120) is thermally coupled to a cold side of the thermoelectric cooling unit (110) and simultaneously exposed to warmer, humid airflow, a continuous transverse temperature gradient exists across capture surfaces during operation; and wherein the airflow channels (130) include micro-fans or passive vents to optimize a volume of air exposed to the cooled condensation surface, wherein the airflow channels (130) is configured to receive ambient air and expose the ambient air to a cold surface generated by the thermoelectric cooling unit, wherein when the air temperature is reduced below its saturation temperature at a predefined humidity ratio, water vapor condenses on the hydrophilic condensation mesh (120).

In this embodiment, the interaction between the thermoelectric cooling unit and the incoming humid airflow is engineered to create a sharply defined thermal transition zone that is confined to the immediate vicinity of the hydrophilic condensation mesh, rather than distributed throughout the internal volume of the apparatus. When the thermoelectric cooling unit is energized, a cold junction is established in direct conductive contact with the condensation mesh, and this interface acts as a localized heat sink that rapidly extracts thermal energy from the adjacent air layers. As ambient air is guided through the airflow channels toward this region, it does not undergo abrupt bulk cooling; instead, the temperature reduction occurs progressively within a thin boundary layer that forms directly over the mesh surface. This ensures that the bulk airflow retains sufficient thermal energy to sustain continuous vapor transport, while only the near-surface air reaches conditions necessary for phase transition. For example, air entering at 32° C. and 65% relative humidity may experience only minor cooling in the core flow region, but within a few hundred microns of the mesh surface, the temperature drops below the dew point (approximately 24-25° C.), initiating localized condensation precisely where heat extraction capacity is highest.

The establishment of a transverse temperature gradient—extending from the colder mesh interface to the relatively warmer bulk airflow—enables simultaneous occurrence of sensible cooling and latent heat exchange within a confined spatial domain. As water vapor begins to condense on the hydrophilic surface, latent heat is released directly at the interface, and this heat is immediately conducted into the cold junction and transported away by the thermoelectric module. Because the cooling unit is dimensioned and controlled to match the rate of latent heat release, the surface temperature of the mesh remains substantially stable even during continuous condensation, preventing thermal drift that could otherwise reduce efficiency. This localized thermal management approach ensures that condensation does not propagate upstream into the airflow channels, thereby avoiding uncontrolled fog formation or droplet carryover.

The airflow channels are further configured to regulate the volume and velocity of incoming air such that the boundary layer thickness remains within a predictable range, enabling consistent diffusion of water vapor toward the condensation surface. In implementations employing micro fans, a low but steady airflow is induced to continuously replenish humid air at the interface, thereby preventing depletion of vapor concentration near the mesh. In passive configurations, vent geometries are designed to exploit natural convection and pressure differentials to achieve similar replenishment without active power consumption. For instance, when the device is operated in a still indoor environment, passive vents maintain a slow but continuous airflow driven by temperature-induced density gradients, ensuring that condensation remains sustained without requiring additional mechanical components.

The hydrophilic condensation mesh itself plays a critical role by providing a high-surface-area interface that promotes nucleation once the local air temperature crosses the saturation threshold corresponding to the prevailing humidity ratio. Because the mesh is simultaneously exposed to the cold junction on one side and humid airflow on the other, it inherently maintains a continuous temperature differential across its thickness. This configuration enhances the rate of heat extraction while also ensuring that newly arriving vapor molecules encounter a surface that is consistently below the dew point. As a result, condensation occurs in a controlled, surface-confined manner with minimal thermal fluctuation.

Through this coordinated arrangement of localized cooling, boundary-layer-controlled phase transition, and regulated airflow exposure, the system achieves a highly efficient condensation mechanism in which energy input is concentrated only where phase change occurs. This leads to improved water yield per unit energy, stable operation across varying ambient conditions, and prevention of performance losses associated with bulk air cooling or uncontrolled condensation regions.

In an embodiment, the thermoelectric cooling unit (110) is configured to actively lower a temperature of the ambient air below its dew point and provide a water vapor to undergo a gas-to-liquid phase change directly on a cooled surface, and wherein the micro water reservoir (150) includes a removable cap and a micro-filter for hygienic storage and retrieval of condensed water.

In this embodiment, the thermoelectric cooling unit is configured not merely as a passive cooling element but as an actively regulated heat extraction interface that directly governs the phase transition of water vapor at a micro scale condensation surface. Upon energization, the thermoelectric module establishes a cold-side junction that is thermally coupled to the hydrophilic condensation mesh through a low-resistance conductive interface, ensuring rapid and uniform transfer of thermal energy away from the mesh. As ambient humid air is directed toward this cooled surface, the air adjacent to the mesh undergoes progressive sensible cooling until its temperature reaches the dew point corresponding to the prevailing humidity conditions. At this threshold, the thermodynamic state of the air transitions from unsaturated to saturated and excess water vapor begins to condense directly onto the mesh surface as liquid droplets.

The process is deliberately confined to the immediate vicinity of the cooled surface, such that the phase change occurs in a controlled boundary layer rather than within the bulk airflow. This ensures that the latent heat released during condensation is immediately absorbed by the thermoelectric unit and transported to its hot side, preventing localized temperature rise that could otherwise inhibit further condensation. For instance, under conditions of 75% relative humidity at 28° C., the system dynamically drives the condensation surface to approximately 22-23° C., thereby maintaining a consistent sub-dew-point condition that sustains continuous droplet formation without requiring excessive power input. The ability to precisely control this temperature differential allows the apparatus to operate efficiently across a wide range of environmental conditions, including fluctuating humidity and temperature profiles.

The condensed water formed on the mesh is guided downward through capillary-assisted pathways into the micro water reservoir, which is structurally integrated beneath the condensation interface. The reservoir is designed with a removable cap that allows periodic access for cleaning, refilling, or direct consumption, thereby enhancing usability in portable applications. Additionally, the inclusion of a micro-scale filtration element within the reservoir ensures that any particulate matter, airborne contaminants, or micro-debris entrained during the condensation process are effectively removed prior to storage. This filtration may be implemented using a fine porous membrane or mesh layer that permits passage of liquid water while restricting particles above a defined size threshold, thereby maintaining the purity of the collected water.

The combination of controlled phase-change induction and hygienic storage architecture enables the apparatus to not only generate water from ambient air but also preserve its quality for safe use. By integrating active thermal regulation with a sealed and filtered collection system, the device achieves a self-contained water generation cycle in which vapor capture, condensation, transport, and storage occur in a continuous and contamination-minimized manner. This results in a compact yet functionally robust system capable of delivering potable water output in environments where conventional water sources are unavailable or impractical.

In an embodiment, the microcontroller unit (160) is configured to execute a closed-loop thermal regulation sequence by continuously acquiring analog or digital signals corresponding to ambient humidity and ambient temperature from the one or more humidity and temperature sensors (140), converting acquired analog or digital signals into calibrated environmental parameters, determining a corresponding dew point temperature based on the calibrated environmental parameters, and generating a control signal that modulates an electrical input supplied from the rechargeable lithium battery (170) to the thermoelectric cooling unit (110), wherein the control signal is iteratively updated at a predefined sampling frequency such that a cold-side surface temperature of the thermoelectric cooling unit (110), thermally coupled to the hydrophilic condensation mesh (120), is maintained below a determined dew point temperature during operation.

In this embodiment, the microcontroller unit is architected to function as a real-time thermodynamic decision engine that continuously aligns the cooling performance of the thermoelectric unit with the instantaneous atmospheric state, thereby ensuring that condensation is sustained under dynamically varying environmental conditions. The humidity and temperature sensors positioned along the airflow path generate electrical signals-either analog voltages proportional to sensed parameters or digitized outputs via integrated sensing elements-which are periodically sampled by the microcontroller through embedded analog-to-digital conversion circuitry or digital communication interfaces. These raw signals are not used directly; instead, they undergo calibration routines stored within the controller memory, including offset correction, linearization, and temperature compensation, to derive accurate representations of ambient humidity ratio and air temperature.

Using these calibrated parameters, the microcontroller computes the dew point temperature through an embedded thermodynamic model, which may include approximations based on Magnus-type relations or lookup tables stored in non-volatile memory for rapid computation. This computed dew point represents the threshold at which condensation can occur for the given air composition. The controller then establishes a target cooling set point that lies below this dew point by a controlled margin, ensuring that the condensation surface remains sufficiently cold to initiate and sustain phase change while avoiding excessive cooling that would increase power consumption or risk frost formation.

A control signal is subsequently generated to regulate the electrical input supplied from the rechargeable lithium battery to the thermoelectric cooling unit. This regulation may be implemented using pulse-width modulation, current control drivers, or voltage regulation circuits integrated with the microcontroller. The control algorithm operates in a closed-loop manner, meaning that the sensed environmental parameters are continuously re-evaluated at a predefined sampling frequency—such as every few milliseconds or seconds depending on system design—and the control signal is iteratively adjusted to maintain the desired thermal condition at the condensation interface. For example, if ambient humidity rises suddenly, the controller detects an increase in dew point and correspondingly reduces the cooling intensity required, thereby conserving energy while maintaining condensation efficiency. Conversely, in drier conditions, the controller increases the cooling drive to ensure that the surface temperature still falls below the updated dew point threshold.

The thermal state of the condensation surface is indirectly inferred through the controlled input to the thermoelectric unit and known thermal characteristics of the system, or optionally through embedded temperature sensing at or near the cold junction. By maintaining the cold-side temperature consistently below the calculated dew point, the system ensures that condensation occurs continuously at the hydrophilic mesh without interruption. This feedback-driven modulation prevents oscillatory thermal behavior, reduces unnecessary energy expenditure, and allows the device to operate autonomously without manual adjustment.

Through this coordinated sensing, computation, and actuation sequence, the apparatus achieves precise synchronization between environmental conditions and cooling performance, resulting in stable condensation rates, improved energy utilization, and reliable operation across a broad spectrum of ambient humidity and temperature scenarios.

In an embodiment, the thermoelectric cooling unit (110) is positioned in direct thermal contact with the hydrophilic condensation mesh (120) such that a conductive heat transfer path is established between a cold junction of the thermoelectric cooling unit (110) and the hydrophilic condensation mesh (120), wherein energization of the thermoelectric cooling unit (110) produces a temperature gradient extending from the cold junction toward ambient air flowing through the airflow channels (130), and wherein the temperature gradient is spatially confined within the condensation chamber (125) such that a boundary layer of air adjacent to the hydrophilic condensation mesh (120) is reduced below a saturation temperature corresponding to the ambient humidity detected by the one or more humidity and temperature sensors (140); and wherein the plurality of airflow channels (130) are dimensioned and arranged to guide ambient humid air along a defined flow path over and through the hydrophilic condensation mesh (120), and wherein the airflow channels (130) are configured to impose a low-Reynolds-number flow regime such that a laminar boundary layer is formed adjacent to the hydrophilic condensation mesh (120), and wherein the laminar boundary layer establishes a controlled diffusion gradient of water vapor from a bulk air stream toward the cooled condensation surface of the hydrophilic condensation mesh (120), resulting in continuous mass transfer of water vapor toward a condensation interface under steady-state flow conditions.

In this embodiment, the thermoelectric cooling unit is physically integrated with the hydrophilic condensation mesh through a direct, low-resistance conductive interface so that thermal energy extracted from the mesh is transferred with minimal loss or delay. This direct thermal coupling ensures that when the thermoelectric unit is energized, the cold junction immediately establishes a localized cooling zone across the thickness of the mesh, rather than relying on indirect or diffused cooling. As a result, a well-defined temperature gradient is formed that extends from the cold junction into the adjacent airflow region, with the lowest temperature maintained at the mesh surface and progressively higher temperatures toward the bulk air stream. The geometry of the condensation chamber is specifically designed to confine this gradient within a limited spatial region, preventing unnecessary cooling of the entire airflow volume and concentrating thermal extraction precisely where phase change is intended to occur.

As humid ambient air is guided through the airflow channels, it encounters this confined thermal gradient and undergoes controlled cooling only within a thin boundary layer adjacent to the mesh. The temperature of this boundary layer is reduced below the saturation temperature corresponding to the measured humidity conditions, thereby initiating condensation at the mesh surface without disturbing the thermodynamic state of the bulk airflow. For instance, in an environment at 30° C. and 60% relative humidity, the boundary layer in contact with the mesh may be selectively cooled to approximately 21-22° C., while the core airflow remains closer to ambient temperature. This selective cooling ensures that condensation is localized, predictable, and energy-efficient, avoiding widespread temperature reduction that would otherwise increase power demand.

The airflow channels are dimensioned with characteristic hydraulic diameters and lengths that maintain airflow within a low Reynolds number regime, thereby ensuring laminar flow conditions as the air passes over and through the mesh. Under such laminar conditions, a stable and well-defined boundary layer develops along the mesh surface, characterized by minimal turbulence and a predictable velocity profile. This is critical because it allows the transport of water vapor toward the condensation surface to be governed primarily by molecular diffusion rather than chaotic mixing. The resulting diffusion gradient-established between the higher vapor concentration in the bulk airflow and the lower concentration at the cooled surface where condensation continuously removes vapor-drives a steady flux of water molecules toward the interface.

Because the laminar boundary layer remains intact and undisturbed, the thickness of this layer and the associated mass transfer coefficient can be precisely controlled through channel geometry and airflow velocity. This enables the system to maintain a consistent rate of vapor transport and condensation over time. For example, by selecting an airflow velocity that avoids transition to turbulence, the device ensures that the diffusion pathway remains stable, allowing continuous replenishment of water vapor at the surface without causing droplet detachment or thermal instability.

The combined effect of direct conductive cooling, spatial confinement of the temperature gradient, and laminar-flow-induced diffusion control results in a highly efficient condensation mechanism. Heat removal, vapor transport, and phase change occur in a synchronized and steady-state manner, enabling continuous water production with minimal fluctuations. This configuration enhances energy efficiency, improves predictability of output, and allows the device to operate reliably across a range of environmental conditions while maintaining a compact form factor suitable for handheld use.

In an embodiment, the hydrophilic condensation mesh (120) comprises a surface structure having a distributed pore network and surface roughness features configured to induce heterogeneous nucleation of water droplets when a surface temperature is maintained below the dew point, and wherein the hydrophilic condensation mesh (120) is further configured to support droplet coalescence through capillary interaction between adjacent nucleation sites, and wherein the coalesced droplets migrate along the surface structure of the hydrophilic condensation mesh (120) under capillary and gravitational forces toward a lower region of the condensation chamber (125) that is fluidly connected to the micro water reservoir (150); and wherein the micro water reservoir (150) is positioned relative to the hydrophilic condensation mesh (120) such that condensed liquid water formed on the hydrophilic condensation mesh (120) is directed into the micro water reservoir (150) through a continuous liquid transport path defined by the surface structure of the hydrophilic condensation mesh (120), and wherein the continuous liquid transport path is maintained by a capillary pressure gradient generated by variations in effective pore size and wettability along the hydrophilic condensation mesh (120), such that liquid accumulation at the condensation interface is reduced during continuous condensation operation.

In this embodiment, the hydrophilic condensation mesh is engineered as an active micro structured interface that not only enables phase transition but also governs post-condensation liquid behavior to sustain uninterrupted operation. The surface of the mesh is formed with a distributed network of micro- and nano-scale pores combined with controlled surface roughness features, which collectively reduce the energy barrier required for heterogeneous nucleation. When the mesh temperature is driven below the dew point, water vapor molecules arriving at the surface preferentially attach to these energetically favorable sites, initiating droplet formation at multiple discrete locations rather than randomly across the surface. This spatially distributed nucleation ensures uniform utilization of the condensation area and prevents localized saturation that could otherwise impede further condensation.

As condensation progresses, adjacent micro droplets begin to interact through capillary forces arising from surface tension and curvature differences. These interactions promote coalescence, wherein smaller droplets merge into larger ones, thereby reducing the total surface energy of the system. The mesh is intentionally designed with gradients in pore size and wettability characteristics—such as relatively finer pores and higher surface energy regions near the cooling interface, and comparatively larger pores or lower resistance pathways toward the downstream direction. This structural variation establishes a capillary pressure differential across the mesh, effectively creating a passive driving force that directs the movement of liquid away from the nucleation sites.

The coalesced droplets, once they reach a critical size or encounter favorable capillary gradients, begin to migrate along the surface of the mesh. This movement is governed by a combination of capillary-driven flow and gravitational assistance, particularly given the orientation of the condensation chamber. For example, droplets formed near the upper or central regions of the mesh are gradually drawn toward lower regions where pore sizes are larger and resistance to flow is reduced. This ensures that liquid does not remain stagnant at the condensation interface, which would otherwise form a thermal barrier and reduce heat transfer efficiency.

The micro water reservoir is strategically positioned directly beneath or downstream of this migration pathway, such that the transported liquid is seamlessly collected without requiring additional pumping or mechanical intervention. The interface between the mesh and the reservoir is configured to maintain a continuous liquid transport path, meaning that once droplets begin to move, they are guided uninterrupted into the region. The capillary pressure gradient along the mesh ensures that this transport remains self-sustaining, even under low-flow or microgravity-like conditions within the confined device geometry.

By continuously removing condensed liquid from the active condensation surface, the system maintains an exposed and thermally efficient interface for ongoing vapor deposition. This prevents flooding of the mesh, minimizes thermal resistance caused by accumulated liquid films, and sustains a high rate of heat and mass transfer. For instance, during prolonged operation in high-humidity conditions, where condensation rates are elevated, the capillary-driven drainage mechanism ensures that droplet accumulation does not choke the surface, thereby preserving consistent performance.

Through this integration of nucleation-enhancing microstructure, capillary-directed droplet transport, and gravity-assisted drainage into a dedicated reservoir, the apparatus achieves a self-regulating liquid management system. This allows continuous condensation, efficient heat exchange, and reliable water collection within a compact architecture, while maintaining operational stability and maximizing water yield over extended use.

In an embodiment, the microcontroller unit (160) is configured to control an activation state of the thermoelectric cooling unit (110) based on a comparison between a detected ambient humidity level and a predefined humidity threshold, and wherein the thermoelectric cooling unit (110) is energized only when the detected ambient humidity level exceeds the predefined humidity threshold, and wherein the microcontroller unit (160) further regulates a duration of energization based on a difference between a detected ambient temperature and a calculated dew point temperature to maintain a sustained temperature differential at the hydrophilic condensation mesh (120).

In this embodiment, the microcontroller unit is configured to implement a condition-responsive activation logic that ensures the thermoelectric cooling unit operates only when ambient conditions are thermodynamically favorable for condensation, thereby avoiding inefficient energy expenditure. The humidity and temperature sensors continuously monitor environmental conditions upstream of the condensation chamber and transmit corresponding electrical signals to the microcontroller, which converts these signals into calibrated humidity and temperature values. The controller then compares the detected humidity level with a predefined threshold that represents the minimum vapor density required to achieve meaningful condensation under the available cooling capacity of the device. This threshold is not arbitrarily selected but is derived from empirical characterization of the system, taking into account factors such as cooling power, airflow rate, and surface area of the condensation mesh.

When the detected humidity falls below this threshold, the microcontroller maintains the thermoelectric cooling unit in a deactivated or standby state, thereby preventing operation under conditions where the energy required to lower the air temperature below the dew point would not yield sufficient condensate. For example, in a low-humidity environment of 30-35% relative humidity at 30° C., the dew point is significantly lower, and achieving condensation would require disproportionate energy input; under such conditions, the system remains inactive. Conversely, when the humidity level exceeds the predefined threshold—such as 60% or higher—the controller initiates energization of the thermoelectric unit, as the dew point is closer to ambient temperature and condensation can be achieved efficiently.

Following activation, the microcontroller further refines operation by regulating the duration and intensity of energization based on the difference between the detected ambient temperature and the calculated dew point temperature. This temperature difference effectively represents the cooling requirement needed to induce condensation. The controller computes this differential in real time and uses it to determine how long and at what power level the thermoelectric unit should operate. For instance, if the ambient temperature is only slightly above the dew point, a short-duration, low-power activation may be sufficient to maintain the condensation surface below the saturation threshold. In contrast, if the temperature-dew point gap is larger, the controller increases the duration or duty cycle of the cooling input to ensure that the mesh temperature is adequately reduced.

This dynamic regulation may be implemented through time-based control cycles, such as duty-cycled activation where the thermoelectric unit is periodically switched on and off, or through continuous modulation using pulse-width or current control techniques. The objective is to maintain a sustained temperature differential at the hydrophilic condensation mesh that is sufficient to support ongoing condensation while minimizing unnecessary cooling. By continuously reassessing ambient conditions and adjusting operation accordingly, the system avoids both undercooling, which would halt condensation, and overcooling, which would waste energy and potentially lead to undesirable effects such as frost formation.

Through this selective activation and duration control strategy, the apparatus achieves an adaptive operating mode that aligns energy consumption with actual condensation potential. This results in improved operational efficiency, extended battery life, and reliable water generation performance across a wide range of environmental conditions without requiring manual intervention or preset operating modes.

In an embodiment, the thermoelectric cooling unit (110) is configured to transfer heat from the hydrophilic condensation mesh (120) to an opposing side of the thermoelectric cooling unit (110) through a solid-state heat pumping mechanism, and wherein latent heat released during condensation of water vapor on the hydrophilic condensation mesh (120) is conducted into the thermoelectric cooling unit (110) and transported away from the condensation chamber (125), such that a temperature rise at the hydrophilic condensation mesh (120) is limited during continuous condensation; and wherein the airflow channels (130) are arranged to introduce ambient air into the condensation chamber (125) along a longitudinal direction of the pen housing (100), and wherein the airflow channels (130) are configured such that a velocity of the ambient air is maintained within a predefined low velocity range to increase a residence time of the ambient air adjacent to the hydrophilic condensation mesh (120), and wherein an increased residence time promotes diffusion-driven transport of water vapor toward the cooled condensation surface of the hydrophilic condensation mesh (120).

In this embodiment, the thermoelectric cooling unit operates as an active solid-state heat pump that continuously extracts thermal energy from the hydrophilic condensation mesh and transfers it to an opposing side of the device, thereby maintaining a stable low-temperature interface required for sustained phase change. When water vapor condenses on the mesh, latent heat is released at the condensation interface, which would ordinarily elevate the local surface temperature and reduce further condensation efficiency. However, due to the direct conductive coupling between the mesh and the cold junction of the thermoelectric unit, this released latent heat is immediately absorbed and transported across the thermoelectric module toward its hot side. This continuous removal of both sensible and latent heat prevents thermal buildup at the condensation surface, ensuring that the mesh temperature remains consistently below the dew point even during prolonged operation. For example, under high-humidity conditions where condensation rates are elevated, the rate of latent heat release increases significantly; the thermoelectric unit correspondingly maintains a proportional heat pumping action, thereby preventing temperature drift that could otherwise suppress further condensation.

The internal airflow architecture is simultaneously configured to complement this heat removal process by controlling how ambient air interacts with the cooled surface. The airflow channels are arranged along a longitudinal axis of the pen-shaped housing, guiding incoming humid air in a directed flow path that maximizes contact with the condensation mesh. Unlike high-velocity systems that prioritize forced convection, this embodiment deliberately maintains airflow within a low velocity range, ensuring that the residence time of air adjacent to the mesh is sufficiently long. This extended residence time allows water vapor molecules within the air to diffuse toward the cooled surface rather than being swept past it before condensation can occur.

The low-velocity regime also supports the formation of a stable boundary layer in which temperature and vapor concentration gradients are maintained. Within this boundary layer, the vapor concentration near the mesh is continuously reduced due to ongoing condensation, while the bulk airflow retains a higher vapor concentration. This difference establishes a diffusion gradient that drives water vapor toward the condensation surface. For instance, when air flows slowly across the mesh, vapor molecules have adequate time to migrate through the boundary layer and reach the cooled interface, resulting in higher condensation efficiency compared to a fast-moving stream where such diffusion would be limited.

By coordinating the heat pumping capability of the thermoelectric unit with the controlled airflow conditions, the system ensures that condensation is not limited by either thermal saturation or insufficient vapor transport. The mesh remains thermally stable due to efficient heat extraction, while the airflow provides a continuous supply of water vapor under conditions that favor diffusion-driven mass transfer. This integrated approach enables steady-state operation in which heat removal, vapor diffusion, and phase change occur concurrently and without interruption, resulting in improved water generation efficiency and consistent performance within the compact geometry of the handheld apparatus.

In an embodiment, the one or more humidity and temperature sensors (140) are positioned within and adjacent to the airflow channels (130) such that environmental measurements are obtained upstream of the condensation chamber (125), and wherein the microcontroller unit (MCU) (160) utilizes upstream environmental measurements to predict a thermodynamic state of the ambient air prior to entry into the condensation chamber (125), and adjusts an electrical input to the thermoelectric cooling unit (110) in accordance with a predicted thermodynamic state; and wherein the hydrophilic condensation mesh (120) is configured to maintain a continuous exposure of cooled surface area to the ambient air by promoting removal of condensed liquid through a combination of capillary-driven transport and gravitational drainage, and wherein accumulation of liquid on the hydrophilic condensation mesh (120) is limited such that a thermal resistance at an interface between the ambient air and the hydrophilic condensation mesh (120) remains within a range that supports continuous heat transfer during condensation.

In this embodiment, the placement of the humidity and temperature sensors upstream of the condensation chamber enables the system to acquire a predictive understanding of the thermodynamic state of the incoming air before it undergoes any cooling or phase interaction. By positioning the sensors within and adjacent to the airflow channels, the measured parameters accurately represent the undisturbed ambient conditions, including absolute humidity, temperature, and corresponding vapor pressure. These measurements are continuously transmitted to the microcontroller unit, which processes the incoming data to estimate key thermodynamic properties such as dew point, vapor density, and enthalpy of the air stream prior to its interaction with the cooled surface. This predictive capability allows the controller to determine, in advance, the level of cooling required inducing condensation once the air reaches the hydrophilic mesh.

Based on this predicted thermodynamic state, the microcontroller dynamically adjusts the electrical input supplied to the thermoelectric cooling unit, ensuring that the cooling capacity is precisely matched to the incoming air conditions. For instance, if the upstream sensors detect a rise in humidity or a decrease in ambient temperature, the controller anticipates a higher dew point and correspondingly reduces the cooling effort needed to achieve condensation. Conversely, under drier or warmer conditions, the controller increases the electrical input to ensure that the mesh temperature still falls below the required saturation threshold. This forward-looking adjustment minimizes response lag and prevents inefficient transient behavior, allowing the system to maintain a stable condensation regime from the moment air enters the chamber.

Simultaneously, the hydrophilic condensation mesh is structured to ensure that its active surface remains continuously available for heat and mass transfer. As condensation occurs, liquid droplets formed on the mesh are immediately mobilized through a combination of capillary forces and gravitational effects. The micro structured surface promotes directional transport of the liquid away from the nucleation sites, preventing the formation of a stagnant liquid film that would otherwise act as an insulating layer. By continuously clearing condensed water from the interface, the mesh maintains direct between the cooled solid surface and the incoming humid air, which is essential for efficient heat extraction and vapor diffusion.

The limitation of liquid accumulation at the interface directly influences the thermal resistance between the airflow and the condensation surface. If a thick liquid layer were to form, it would impede heat transfer by introducing an additional thermal barrier and reducing the effective temperature gradient driving condensation. In this embodiment, the coordinated design of surface morphology and drainage pathways ensures that the thickness of any liquid layer remains minimal and within a controlled range. For example, even during periods of high condensation rates, the capillary-driven transport continuously removes excess liquid, maintaining a thin, transient film that does not significantly disrupt heat flow.

Through the integration of upstream environmental prediction and continuous surface renewal, the system achieves a highly responsive and stable condensation process. The cooling input is proactively aligned with incoming air conditions, while the condensation surface remains unobstructed and thermally efficient. This results in consistent heat transfer, sustained vapor diffusion, and uninterrupted water collection, enabling reliable operation across varying environmental scenarios within the compact constraints of the handheld apparatus.

In an embodiment, the thermoelectric cooling unit (110), the hydrophilic condensation mesh (120), and the airflow channels (130) are arranged within the condensation chamber (125) such that a localized temperature gradient is established between a cooled surface region of the hydrophilic condensation mesh (120) and a bulk air stream within the airflow channels (130), and wherein the localized temperature gradient induces a continuous diffusion flux of water vapor toward the cooled surface region, resulting in steady-state condensation under continuous airflow conditions; and wherein the microcontroller unit (160) is configured to compute a dew point temperature corresponding to sensed ambient humidity and temperature values and to continuously update a target cooling setpoint defined as a fixed temperature offset below a computed dew point, and wherein the microcontroller unit (160) modulates an electrical current supplied to the thermoelectric cooling unit (110) in accordance with a deviation between the target cooling setpoint and an inferred surface temperature of the hydrophilic condensation mesh (120) such that the inferred surface temperature remains within a bounded sub-dew-point range during steady-state operation.

In this embodiment, the internal arrangement of the thermoelectric cooling unit, the hydrophilic condensation mesh, and the airflow channels is deliberately configured to create a confined thermodynamic interaction zone in which temperature and vapor concentration gradients are co-located and mutually reinforcing. The thermoelectric cooling unit establishes a cooled surface region at the mesh, while the airflow channels deliver a comparatively warmer and vapor-rich air stream across this surface. This spatial arrangement produces a localized temperature gradient that is sharply defined between the cooled mesh interface and the bulk airflow, rather than being distributed across the entire chamber volume. As a result, the air immediately adjacent to the mesh experiences a reduction in temperature below its saturation threshold, while the core airflow retains higher vapor content, thereby sustaining a continuous driving force for vapor transport.

Within this localized gradient, a stable diffusion flux of water vapor is established, governed by the difference in vapor concentration between the bulk airflow and the saturated conditions at the cooled surface. Because condensation continuously removes vapor at the interface, the local vapor concentration near the mesh remains lower than that of the incoming air, thereby maintaining a persistent diffusion gradient. This enables water vapor molecules to migrate steadily toward the cooled surface under diffusion-controlled conditions, even when airflow velocities are relatively low. For example, during operation in an environment with moderate humidity, the system maintains a consistent vapor flux toward the mesh without requiring turbulent mixing, thereby preserving energy efficiency while ensuring continuous condensation.

The microcontroller unit operates in parallel with this physical configuration by dynamically computing the dew point temperature based on real-time sensor inputs representing ambient humidity and temperature. Using this computed dew point, the controller defines a target cooling set point that is intentionally offset below the dew point by a predetermined margin, ensuring that the condensation surface remains within an optimal sub-saturation range. This offset is selected to balance efficient condensation with avoidance of excessive cooling that could lead to energy inefficiency or undesirable phase transitions such as frost formation.

To maintain this target condition, the microcontroller continuously modulates the electrical current supplied to the thermoelectric cooling unit. This modulation is based on a comparison between the target cooling set point and the inferred or measured temperature of the condensation mesh. The inferred surface temperature may be derived from known thermal characteristics of the system combined with input power levels, or through direct sensing at the mesh interface. Any deviation from the target range triggers an adjustment in the electrical input, such as increasing current when the surface temperature rises above the desired level or reducing current when the surface becomes excessively cold.

This closed-loop regulation ensures that the condensation surface temperature remains within a bounded range below the dew point, thereby stabilizing the rate of condensation and preventing oscillatory thermal behavior. For instance, if ambient conditions fluctuate due to changes in humidity or airflow, the controller rapidly recalculates the dew point and updates the cooling set point, ensuring that the localized temperature gradient remains effective in driving vapor diffusion. The result is a steady-state operating condition in which heat removal, vapor transport, and phase change are continuously balanced.

Through this coordinated interaction between structural arrangement and adaptive control, the system achieves a sustained and predictable condensation process. The localized temperature gradient ensures efficient vapor delivery to the surface, while the dynamically maintained sub-dew-point condition preserves consistent condensation without energy overshoot. This enables reliable water generation performance within a compact form factor, even under varying environmental conditions.

In an embodiment, the thermoelectric cooling unit (110) is operated under a controlled transient regime in which an initial high-current activation phase is applied to rapidly establish a sub-dew-point condition at the hydrophilic condensation mesh (120), followed by a reduced-current maintenance phase governed by the microcontroller unit (160), wherein the transition between the initial high-current activation phase and the reduced-current maintenance phase is determined based on a rate of change of sensed ambient temperature and humidity signals; and wherein the airflow channels (130) and the hydrophilic condensation mesh (120) are arranged such that a vapor depletion region is formed adjacent to the hydrophilic condensation mesh (120) during operation, and wherein continuous condensation at the hydrophilic condensation mesh (120) establishes a localized reduction in vapor partial pressure that produces a sustained diffusion gradient from upstream regions of the airflow channels (130) toward the condensation chamber (125).

In this embodiment, the thermoelectric cooling unit is driven according to a time-varying control strategy that distinguishes between a start-up transient and a steady operating condition, thereby enabling rapid establishment of condensation followed by energy-efficient maintenance. At the moment of activation, the microcontroller commands a high-current input to the thermoelectric module, which produces an accelerated heat pumping effect at the cold junction. This initial phase is designed to quickly pull the temperature of the hydrophilic condensation mesh below the dew point corresponding to the sensed ambient conditions, overcoming the thermal inertia of the mesh and surrounding structure. For example, if the incoming air is at 30° C. and 65% relative humidity, the system may momentarily drive the cooling unit at an elevated current level to reduce the mesh temperature from ambient to approximately 22-23° C. within a short interval, ensuring that condensation begins without delay.

Once this sub-dew-point condition is achieved, the system does not continue operating at the same high input level. Instead, the microcontroller transitions the thermoelectric unit into a reduced-current maintenance phase in which only the energy required to offset ongoing heat gains—such as latent heat released during condensation and convective heat transfer from incoming air—is supplied. The determination of when to transition between these phases is not based on a fixed time interval but is dynamically evaluated using the rate of change of sensed environmental parameters. If the sensors indicate stable ambient conditions with minimal variation in temperature and humidity, the controller shortens the high-current phase and shifts quickly to maintenance mode. Conversely, if rapid fluctuations are detected, the controller prolongs or intermittently reintroduces higher current input to maintain the required sub-dew-point condition. This adaptive transient control ensures that the cooling response remains synchronized with environmental dynamics, avoiding both delayed condensation onset and unnecessary energy expenditure.

Simultaneously, the physical arrangement of the airflow channels and the hydrophilic condensation mesh is configured to support a mass transfer regime in which vapor availability near the condensation surface is continuously regulated. As condensation proceeds on the mesh, water vapor is removed from the adjacent air layer, resulting in a localized reduction in vapor partial pressure. This creates what can be described as a vapor depletion region directly adjacent to the mesh surface. Because the bulk airflow upstream retains a higher vapor concentration, a gradient in vapor partial pressure is established along the flow direction.

This gradient becomes the driving force for diffusion of water vapor from upstream regions toward the condensation interface. The airflow channels are dimensioned and oriented to maintain a steady supply of humid air while avoiding excessive turbulence that would disrupt the formation of this gradient. As a result, even though condensation continuously consumes vapor at the surface, the depletion is immediately compensated by diffusion-driven transport from regions of higher concentration. For instance, during sustained operation, the vapor concentration near the mesh remains lower than that in the incoming airflow, ensuring a persistent inward flux of vapor molecules that supports uninterrupted condensation.

The combination of transient thermal control and spatially structured vapor transport results in a system that rapidly initiates condensation and then maintains it in a stable, energy-efficient manner. The initial high-current phase minimizes delay in reaching operational conditions, while the subsequent maintenance phase ensures that only the cooling effort is applied. At the same time, the formation of a vapor depletion region and the resulting diffusion gradient guarantee a continuous supply of water vapor to the cooled surface, preventing performance degradation due to local vapor exhaustion. This coordinated approach enables consistent water generation with reduced power consumption and improved responsiveness to changing environmental conditions.

In an embodiment, the thermoelectric cooling unit (110) is configured to operate based on a Peltier effect in which an electrical current passing through a junction of dissimilar conductive materials produces heat absorption at the hydrophilic condensation mesh (120) and heat rejection at an opposing region of the thermoelectric cooling unit (110), and wherein the microcontroller unit (160) regulates a magnitude of the electrical current to control a rate of heat absorption at the hydrophilic condensation mesh (120).

In an embodiment, the hydrophilic condensation mesh (120) is configured to generate a non-uniform temperature field across its surface due to differential thermal coupling with the thermoelectric cooling unit (110), and wherein the non-uniform temperature field establishes spatially distributed condensation zones including a primary nucleation region and a secondary coalescence region, such that initial droplet formation occurs at colder regions and droplet growth and transport occur at relatively warmer adjacent regions; and wherein the hydrophilic condensation mesh (120) is configured to maintain a continuous liquid transport pathway by establishing a capillary pressure gradient along a thickness and surface of the hydrophilic condensation mesh (120), wherein smaller effective pore regions located proximate to a thermoelectric cold junction retain condensed liquid during initial nucleation and larger effective pore regions located downstream release liquid toward the micro water reservoir (150) upon exceeding a capillary breakthrough condition.

In this embodiment, the hydrophilic condensation mesh is intentionally designed to exhibit spatially varying thermal characteristics rather than a uniformly cooled surface, thereby creating functionally distinct regions that sequentially support nucleation, growth, and transport of condensed water. This non-uniform temperature field arises from differential thermal coupling between the mesh and the thermoelectric cooling unit, wherein regions in closer proximity to the cold junction experience stronger conductive heat extraction and are maintained at lower temperatures, while regions farther from the junction or more exposed to incoming airflow experience comparatively higher temperatures. As a result, the surface of the mesh develops a controlled temperature gradient across its lateral extent and thickness, which directly influences the local thermodynamic conditions for condensation.

In operation, the colder regions of the mesh act as primary nucleation zones where the energy barrier for phase transition is lowest. Water vapor molecules arriving at these encounter surface temperatures sufficiently below the dew point, leading to rapid initiation of droplet formation at discrete nucleation sites. Because these regions are maintained at lower temperatures, they favor the continuous generation of fine droplets without immediate detachment. Adjacent to these zones, slightly warmer regions form secondary zones where droplets that have nucleated upstream begin to grow through coalescence and accumulation. The temperature difference between these regions ensures that while nucleation is concentrated at the colder, droplet growth and mobility are enhanced in the relatively warmer areas, where surface adhesion forces are reduced and liquid mobility is higher.

The mesh structure is further engineered to translate this thermal gradient into a directional liquid transport mechanism through controlled variation in pore size and wettability. Near the colder nucleation regions, the mesh comprises smaller effective pores and higher capillary retention characteristics, which hold the initially formed droplets in place long enough to ensure stable nucleation and growth. As droplets increase in size and extend into adjacent regions with larger pores and lower capillary resistance, a capillary pressure gradient is established along the surface and through the thickness of the mesh. This gradient acts as a driving force that induces movement of liquid from regions of higher capillary pressure (smaller pores) toward regions of lower capillary pressure (larger pores).

Once the accumulated liquid reaches regions where the capillary holding force is exceeded—referred to as the capillary breakthrough condition—the droplets are released and begin to migrate toward the downstream collection pathway. This migration is further assisted by gravitational forces due to the orientation of the condensation chamber, ensuring that liquid transport proceeds in a controlled and continuous manner toward the micro water reservoir. For example, droplets formed at colder upstream zones gradually move laterally and downward into coalescence regions and eventually detach into the reservoir once there and the local pore structure permit.

By separating the functions of nucleation, growth, and drainage across different thermal and structural regions of the mesh, the system avoids the common limitation of surface flooding that occurs when all processes compete within the same area. The colder zones remain exposed and continuously active for new condensation events, while the warmer zones facilitate efficient removal of accumulated liquid. This division of roles ensures that the condensation surface is continuously regenerated, maintaining high heat transfer efficiency and preventing the formation of insulating liquid films.

Through this coordinated interplay of non-uniform thermal distribution and capillary-driven liquid transport, the apparatus achieves a self-organizing condensation process in which droplet formation, enlargement, and removal occur in a synchronized and spatially optimized manner. This results in sustained condensation rates, improved water collection efficiency, and stable operation even under conditions of high humidity and prolonged use.

In an embodiment, the thermoelectric cooling unit (110) and the hydrophilic condensation mesh (120) are operated such that a condensation mass flux at the hydrophilic condensation mesh (120) is governed by a vapor density gradient between ambient air flowing through the airflow channels (130) and a saturated vapor condition at the cooled condensation surface of the hydrophilic condensation mesh (120), and wherein the microcontroller unit (160) regulates an electrical input to the thermoelectric cooling unit (110) such that the vapor density gradient is maintained at a non-zero value during operation; and wherein a condensation process occurring at the hydrophilic condensation mesh (120) is characterized by a coupled heat and mass transfer condition in which a rate of latent heat release associated with condensation of water vapor is balanced by a rate of heat removal through the thermoelectric cooling unit (110), and wherein the microcontroller unit (160) controls the thermoelectric cooling unit (110) to maintain the balance between latent heat generation and conductive heat removal across a thermoelectric junction.

In this embodiment, the condensation process is governed by a deliberately sustained vapor density gradient established between the incoming ambient air and the cooled surface of the hydrophilic condensation mesh, such that mass transfer of water vapor is continuously driven toward the condensation interface. As ambient air flows through the airflow channels, it carries a certain vapor density corresponding to its humidity and temperature, whiles the surface of the mesh-being actively cooled by the thermoelectric unit-maintains a condition close to saturation at a lower temperature. This difference in vapor density between the bulk airflow and the near-surface saturated layer creates a persistent driving force for diffusion of water vapor toward the mesh. The system is specifically operated such that this gradient is never allowed to collapse to zero, because a zero-gradient condition would indicate equilibrium and cessation of net condensation.

The microcontroller unit plays a critical role in preserving this non-zero gradient by continuously regulating the electrical input to the thermoelectric cooling unit. Using real-time environmental inputs, the controller determines the required cooling intensity to ensure that the surface vapor pressure at the mesh remains lower than that of the incoming air. If the cooling is insufficient, the surface temperature may rise, increasing the local saturation vapor density and weakening the gradient, which would reduce condensation rate. Conversely, excessive cooling could lead to diminishing returns in mass transfer relative to energy input. Therefore, the controller dynamically adjusts the current supplied to the thermoelectric module so that the surface condition remains optimally offset from the ambient state, thereby sustaining continuous vapor flux toward the interface.

Simultaneously, the condensation process at the mesh is characterized by a tightly coupled interaction between heat transfer and mass transfer phenomena. As water vapor condenses into liquid, latent heat is released at the surface, which must be removed efficiently to prevent an increase in surface temperature that would inhibit further condensation. The thermoelectric cooling unit provides this heat removal through a conductive pathway at the cold junction, transferring the absorbed thermal energy to its opposite side. The system is operated such that the rate of heat removal closely matches the rate of latent heat generation associated with ongoing condensation. This balance is essential because any mismatch would disrupt the stability of the condensation process-insufficient heat removal would cause surface warming and reduced condensation, while excessive cooling would increase energy consumption without proportional gain in water production.

For example, under steady ambient conditions, the controller monitors the inferred thermal load on the condensation surface and modulates the thermoelectric input so that the heat extracted corresponds to the latent heat released by the condensing vapor. This ensures that the surface temperature remains nearly constant even as condensation continues, thereby maintaining a stable vapor density difference across the interface. The airflow conditions further support this balance by continuously supplying fresh humid air, preventing depletion of vapor in the vicinity of the mesh.

Through this coordinated regulation of vapor density gradient and thermal balance, the system achieves a steady-state condensation regime in which mass transfer and heat transfer are synchronized. This result in continuous and efficient water generation, with minimized thermal fluctuations and optimized energy utilization, enabling reliable operation of the apparatus across varying environmental conditions while maintaining a compact and portable form factor.

In an embodiment, the hydrophilic condensation mesh (120) and the airflow channels (130) are configured such that a local condensation mass flux is proportional to a difference between an ambient vapor density and a saturation vapor density corresponding to a surface temperature of the hydrophilic condensation mesh (120), and wherein the surface temperature is actively regulated by the thermoelectric cooling unit (110) under control of the microcontroller unit (160) to sustain continuous condensation; and wherein the microcontroller unit (160) is configured to regulate operation of the thermoelectric cooling unit (110) such that a temperature of the hydrophilic condensation mesh (120) is maintained at a level that produces a vapor pressure at the cooled condensation surface of the condensation mesh (120) lower than a vapor pressure of incoming ambient air, thereby establishing a continuous vapor diffusion flux toward the cooled condensation surface.

In this embodiment, the condensation behavior at the hydrophilic mesh is governed by a quantitatively controlled mass transfer relationship in which the rate of condensation is directly dependent on the difference between the vapor density of the incoming air and the saturation vapor density at the cooled surface. The airflow channels are designed to deliver ambient air with minimal disturbance to its initial thermodynamic state, ensuring that the vapor density entering the condensation chamber accurately reflects environmental conditions. As this air encounters the hydrophilic mesh, the thermoelectric cooling unit maintains the surface at a temperature sufficiently below ambient, thereby lowering the saturation vapor density at the interface. This creates a measurable and sustained difference between the vapor density of the bulk airflow and that at the cooled surface, which acts as the driving force for diffusion of water vapor toward the mesh.

The proportional relationship between this vapor density difference and the local condensation mass flux allows the system to be predictively controlled. The microcontroller continuously evaluates environmental inputs and determines the required surface temperature that will maintain an optimal density difference. Rather than operating the thermoelectric unit at a fixed power level, the controller dynamically adjusts the electrical input so that the surface temperature of the mesh is held within a narrow band that maximizes condensation efficiency. For example, if ambient conditions correspond to a vapor density that would yield a dew point of approximately 24° C., the controller may regulate the mesh temperature to around 20-22° C., ensuring that the saturation vapor density at the surface remains lower than that of the incoming air. This controlled offset ensures that condensation proceeds continuously without excessive cooling.

The microcontroller further refines this process by regulating the thermoelectric unit to maintain a consistent vapor pressure differential between the incoming air and the condensation surface. Because vapor pressure is directly related to vapor density and temperature, maintaining the surface at a lower temperature ensures that the equilibrium vapor pressure at the interface is reduced. This creates a persistent condition in which the vapor pressure of the ambient air exceeds that at the surface, thereby driving a continuous diffusion flux of water vapor toward the mesh. The system is designed such that this pressure differential is neither too small-risking stagnation of condensation-nor excessively large, which would increase energy consumption without proportional gains in water yield.

During operation, as condensation removes vapor from the air adjacent to the mesh, the local vapor density near the surface decreases, reinforcing the gradient between the bulk airflow and the interface. The airflow channels ensure a steady replenishment of humid air, maintaining this gradient over time. The thermoelectric cooling unit simultaneously removes the latent heat released during condensation, preventing any rise in surface temperature that could reduce the vapor pressure differential.

Through this coordinated regulation of surface temperature and vapor pressure conditions, the system achieves a stable and continuous condensation process in which mass transfer is sustained by a controlled thermodynamic imbalance. This approach enables efficient utilization of cooling energy, consistent water generation rates, and adaptability to changing ambient conditions, all within the constraints of a compact handheld device.

In an embodiment, the airflow channels (130) and the hydrophilic condensation mesh (120) are configured such that a boundary layer, adjacent to the hydrophilic condensation mesh (120), exhibits simultaneous gradients of temperature and vapor concentration, and wherein the stable temperature gradient induces sensible cooling of the air and a vapor concentration gradient induces diffusive transport of water vapor toward the hydrophilic condensation mesh (120) within a same spatial region.

In this embodiment, the airflow channels and the hydrophilic condensation mesh are co-designed to create a tightly controlled interfacial zone in which both thermal and mass transport gradients coexist and interact within a single, confined boundary layer adjacent to the mesh surface. As ambient humid air is guided through the airflow channels, it encounters the cooled surface of the mesh, which is maintained at a temperature lower than the bulk air by the thermoelectric cooling unit. This establishes a temperature gradient perpendicular to the surface, where the air temperature progressively decreases from the bulk flow toward the mesh. Within this same region, condensation continuously removes water vapor from the air immediately adjacent to the surface, thereby creating a simultaneous vapor concentration gradient, with lower vapor concentration near the mesh and higher concentration in the bulk airflow.

These two gradients-thermal and concentration—are not independent but are spatially aligned within the boundary layer, resulting in a coupled transport phenomenon. The temperature gradient induces sensible cooling of the air as it approaches the surface, reducing the kinetic energy of the air molecules and bringing the local air state closer to saturation. At the same time, the reduction in vapor concentration at the interface due to ongoing condensation establishes a diffusion-driven flux of water vapor from the bulk air toward the mesh. Because both gradients exist within the same thin region, the cooling process directly enhances the mass transfer process, ensuring that vapor molecules reaching the interface encounter conditions favorable for immediate phase transition.

The airflow channels are dimensioned to maintain a controlled flow regime that preserves the integrity of this boundary layer, avoiding turbulence that could disrupt the gradients. Under such conditions, the thickness and stability of the boundary layer remain predictable, allowing consistent interaction between heat transfer and mass transfer processes. For example, as air flows steadily over the mesh, the temperature drop within the boundary layer reduces the local saturation threshold, while the concurrent vapor depletion ensures that a continuous concentration difference is maintained. This dual-gradient configuration enables efficient utilization of the cooled surface, as both the thermal driving force for condensation and the mass transport of vapor are maximized within the same spatial domain.

As condensation proceeds, the latent heat released at the surface is conducted away through the thermoelectric unit, preventing any local rise that could weaken the temperature gradient. Simultaneously, the airflow replenishes the bulk region with fresh humid air, maintaining the concentration gradient over time. This coordinated interaction ensures that the boundary layer remains a zone for sensible cooling and vapor diffusion, rather than becoming saturated or thermally uniform.

By enabling simultaneous and spatially overlapping gradients of temperature and vapor concentration, the system achieves a highly efficient condensation mechanism in which heat removal and mass transfer are inherently coupled. This results in sustained diffusion of water vapor toward the mesh, stable condensation rates, and improved overall performance, particularly under low airflow or compact device conditions where efficient use of limited surface area is critical.

In an embodiment, the thermoelectric cooling unit (110) is controlled such that a temperature difference between a cold side and ambient air is maintained within a range that produces a condensation mass flux sufficient to sustain droplet formation while preventing a transition to frost formation at the hydrophilic condensation mesh (120), and wherein the hydrophilic condensation mesh (120) is configured such that a thickness and pore structure of the hydrophilic condensation mesh (120) establish a resistance to vapor diffusion that, in combination with airflow velocity within the airflow channels (130), produces a controlled mass transfer coefficient governing condensation rate at the cooled condensation surface of the condensation mesh (120); and wherein the airflow channels (130) and the hydrophilic condensation mesh (120) are configured such that a Peclet number associated with airflow and vapor diffusion remains within a range that supports diffusion-dominated mass transfer toward the cooled condensation surface; wherein the microcontroller unit (160) is configured to regulate operation of the thermoelectric cooling unit (110) such that a ratio of heat removed by the thermoelectric cooling unit (110) to a mass of condensed water remains within a range corresponding to a latent heat of vaporization of water under ambient conditions.

In this embodiment, the thermoelectric cooling unit is operated under a finely regulated thermal envelope in which the temperature difference between the cold side of the module and the surrounding ambient air is deliberately constrained to a range that is sufficient to initiate and sustain condensation while avoiding conditions that would promote frost formation. The microcontroller continuously interprets ambient humidity and temperature inputs to determine an appropriate sub-dew-point operating window, ensuring that the surface temperature of the hydrophilic mesh remains low enough to enable droplet nucleation but not so low that the local temperature approaches freezing under given humidity conditions. For example, in moderately humid air at around 25-30° C., the controller may maintain the mesh temperature within a narrow band of approximately 3-8° C. below the dew point, which supports continuous liquid-phase condensation without crossing into a regime where ice nucleation could occur. This controlled temperature differential ensures stable droplet formation and avoids performance degradation associated with frost buildup, which would otherwise block pores and increase thermal resistance.

The hydrophilic condensation mesh is simultaneously engineered with a specific thickness and internal pore architecture that introduces a defined resistance to vapor diffusion. Rather than allowing unrestricted vapor penetration, the pore network creates a controlled pathway that moderates the rate at which vapor molecules reach the condensation interface. This structural resistance, when combined with the selected airflow velocity within the channels, establishes a predictable mass transfer coefficient that governs the rate of condensation. In practice, the airflow is maintained at a velocity that is low enough to preserve a stable boundary layer yet sufficient to replenish vapor near the mesh surface, ensuring that diffusion remains the dominant transport mechanism. The interplay between mesh permeability and airflow velocity allows the system to avoid extremes such as vapor starvation (if diffusion is too slow) or inefficient bypassing of the surface (if airflow is too fast).

The combined transport behavior can be characterized by maintaining the Peclet number of the system within a range where diffusive transport dominates over convective transport. By ensuring that this dimensionless parameter remains within a controlled range, the system guarantees that vapor molecules migrate toward the cooled surface primarily due to concentration gradients rather than being carried past the surface by bulk flow. This condition stabilizes the condensation process, as it allows consistent replenishment of vapor at the interface while maintaining a predictable and uniform condensation rate across the mesh.

In parallel with these mass transfer considerations, the microcontroller regulates the thermoelectric cooling unit such that the thermal energy removed from the condensation surface corresponds closely to the latent heat associated with the amount of water being condensed. This is achieved by monitoring operating conditions and adjusting the electrical input so that the ratio of heat extraction to condensed mass remains aligned with the thermodynamic requirement for phase change. For instance, as condensation rates increase under higher humidity, the controller proportionally increases the cooling effort to remove the latent heat released, thereby maintaining a stable surface temperature. Conversely, under lower condensation rates, the cooling input is reduced to avoid unnecessary energy consumption.

This coordinated control of temperature differential, diffusion resistance, airflow characteristics, and heat-to-mass balance results in a stable and efficient condensation regime. The system maintains optimal droplet formation conditions without transitioning to frost, ensures controlled and predictable vapor transport to the surface, and aligns energy input with actual phase-change demand. This leads to consistent water generation performance, improved energy efficiency, and reliable operation across varying environmental conditions within the compact structure of the apparatus.

In an embodiment, the thermoelectric cooling unit (110) is arranged relative to the hydrophilic condensation mesh (120) such that a non-uniform thermal coupling is established across a thickness and lateral extent of the hydrophilic condensation mesh (120), wherein regions of the hydrophilic condensation mesh (120) in direct proximity to a cold junction of the thermoelectric cooling unit (110) are maintained at a lower temperature relative to regions exposed to incoming airflow within the airflow channels (130), and wherein the non-uniform thermal coupling produces a spatial temperature gradient across the hydrophilic condensation mesh (120) that induces preferential nucleation of water droplets at colder regions and directional migration of condensed liquid toward relatively warmer regions in fluid communication with the micro water reservoir (150).

In this embodiment, the thermoelectric cooling unit is intentionally positioned and interfaced with the hydrophilic condensation mesh in a manner that produces a non-uniform thermal coupling rather than a uniform temperature field, thereby creating a controlled spatial variation in surface temperature across both the thickness and lateral dimensions of the mesh. The regions of the mesh that are in direct physical proximity to the cold junction experience stronger conductive heat extraction and are therefore maintained at comparatively lower temperatures, while regions that are either farther from the junction or more exposed to the incoming airflow experience reduced cooling intensity due to convective heat gain. This arrangement establishes a deliberate temperature gradient across the mesh surface, with colder zones near the cooling interface and relatively warmer zones toward the airflow-exposed regions.

As humid air passes over this thermally graded surface, water vapor preferentially condenses at the colder regions where the local surface temperature is significantly below the dew point, thereby lowering the energy barrier for nucleation. These regions act as primary condensation sites where initial droplet formation is concentrated. Because these zones are thermally stable and continuously maintained at lower temperatures, they support repeated nucleation events without being hindered by premature droplet detachment. Adjacent to these colder regions, the relatively warmer areas of the mesh provide conditions that are more favorable for droplet growth and mobility. The slight increase in temperature reduces the adhesion forces between the liquid and the surface, enabling droplets to coalesce and become more mobile.

The presence of this temperature gradient induces a directional driving force for liquid movement across the mesh. As droplets grow in size within the colder nucleation zones, they extend into neighboring warmer regions where capillary resistance is lower and surface mobility is higher. This results in a thermally assisted migration mechanism in which condensed liquid is naturally transported away from the nucleation sites toward downstream that are in fluid communication with the micro water reservoir. The mesh structure may further enhance this behavior through variations in pore size and wettability that align with the thermal gradient, reinforcing the directional flow of liquid.

For example, during continuous operation, droplets formed at the coldest near the thermoelectric interface gradually merge and move laterally and downward toward regions where the combined effects of reduced capillary retention and gravitational forces enable release into the reservoir. This ensures that the nucleation zones remain exposed and free from liquid accumulation, thereby preserving their effectiveness for ongoing condensation. At the same time, the warmer regions act as transitional pathways that facilitate efficient drainage without requiring external forces or mechanical intervention.

By establishing non-uniform thermal coupling across the mesh, the system effectively separates the functions of droplet formation and liquid removal into different spatial regions, preventing interference between these processes. This enhances the continuity of condensation, maintains optimal heat transfer conditions at the interface, and reduces the likelihood of surface flooding. The resulting behavior enables a self-sustaining cycle in which vapor condensation, droplet growth, and liquid transport occur in a coordinated and directional manner, leading to improved efficiency and stable operation within the compact confines of the device.

In an embodiment, the plurality of airflow channels (130) are geometrically configured relative to the condensation chamber (125) such that ambient air is guided along a flow path that sequentially exposes the air to progressively decreasing surface temperatures along the hydrophilic condensation mesh (120), wherein an upstream portion of the hydrophilic condensation mesh (120) initiates partial sensible cooling of the air without full condensation and a downstream portion of the hydrophilic condensation mesh (120), maintained at a lower temperature by the thermoelectric cooling unit (110), induces a dew-point crossing within a boundary layer adjacent to the hydrophilic condensation mesh (120), resulting in staged condensation along the flow path; and wherein the hydrophilic condensation mesh (120), the thermoelectric cooling unit (110), and the airflow channels (130) are arranged within the condensation chamber (125) such that a coupled thermo-capillary transport condition is established, wherein condensation-induced liquid formation at the hydrophilic condensation mesh (120) produces a local capillary pressure field governed by pore-scale curvature of the hydrophilic condensation mesh (120), and wherein the local capillary pressure field drives liquid transport away from a condensation interface toward the micro water reservoir (150) while simultaneously maintaining an exposed cold surface for continued vapor diffusion, such that condensation, heat removal, and liquid transport occur concurrently within the condensation chamber (125).

In this embodiment, the airflow channels are geometrically tailored to create a controlled longitudinal interaction between the incoming air stream and the hydrophilic condensation mesh, such that the air experiences a staged thermal conditioning rather than an abrupt temperature drop. As ambient humid air enters the condensation chamber, it is first directed over an upstream portion of the mesh that is maintained at a moderately reduced temperature relative to the ambient. In this region, the air undergoes sensible cooling, meaning its temperature is lowered without immediately reaching saturation. This pre-conditioning stage reduces the thermal load on downstream regions and gradually shifts the air state closer to its dew point while preserving most of its vapor content. For example, air entering at 30° C. may be cooled to approximately 26-27° C. in the upstream section without initiating condensation.

As the air continues along the guided flow path, it encounters downstream regions of the mesh that are more strongly thermally coupled to the thermoelectric cooling unit and therefore maintained at lower temperatures. In this region, the boundary layer adjacent to the mesh is cooled below the dew point corresponding to the pre-conditioned air, resulting in a localized dew-point crossing. Because the air has already been partially cooled upstream, the energy required to induce condensation downstream is reduced, allowing the system to achieve phase transition more efficiently. This sequential exposure to decreasing temperatures ensures that condensation occurs in a controlled and spatially distributed manner along the flow path, rather than being concentrated at a single, thereby improving utilization of the available surface area.

Simultaneously, the structural and thermal arrangement of the mesh, thermoelectric unit, and airflow channels establishes a coupled thermo-capillary transport regime in which condensation, heat removal, and liquid transport are inherently linked. As water vapor condenses on the cooled mesh, droplets form within the pore structure, generating local capillary pressure fields determined by the curvature of the liquid interfaces within the pores. These capillary pressures vary across the mesh due to differences in pore size and local saturation conditions, creating a driving force that moves liquid away from the of active condensation.

This capillary-driven transport operates concurrently with the thermal gradient established across the mesh. As droplets form in colder downstream regions, they are drawn toward adjacent regions where pore geometry and capillary pressure favor liquid movement. The presence of this pressure gradient ensures that condensed liquid does not accumulate at the interface but is continuously displaced toward the micro water reservoir. For instance, droplets formed at the coldest zones migrate through interconnected pores and surface pathways toward lower regions, eventually reaching the reservoir without obstructing the active condensation surface.

At the same time, the thermoelectric cooling unit continues to extract the latent heat released during condensation, maintaining the temperature gradient required for ongoing vapor diffusion. The airflow channels sustain a continuous supply of humid air, ensuring that vapor concentration near the surface remains below that of the bulk flow, thereby preserving the diffusion driving force. Because liquid removal occurs simultaneously with heat extraction and vapor transport, the condensation surface remains exposed and thermally efficient throughout operation.

This coordinated mechanism enables a multi-stage and self-regulating process in which air pre-conditioning, phase change, and liquid evacuation are spatially and functionally integrated. The staged cooling reduces energy demand, the controlled dew-point crossing ensures efficient condensation, and the capillary-driven drainage maintains surface availability. Together, these interactions produce a stable and continuous water generation process within the compact confines of the condensation chamber, with improved efficiency and sustained performance over extended periods of use.

In an embodiment, the primary and enabling trigger for condensation is thermal dew-point depression produced by the thermoelectric cooling unit (110). When the condensation surface associated with the hydrophilic condensation mesh (120) is actively cooled to a temperature below the dew point of the incoming ambient air, the local vapor pressure at the surface exceeds the saturation vapor pressure corresponding to the reduced temperature. This thermodynamic condition forces water vapor to undergo a gas-to-liquid phase transition. Condensation, therefore, initiates solely due to a reduction in temperature below the dew point, independent of electric fields or chemical binding.

Surface energy characteristics of the condensation mesh (120) play a secondary, enabling role rather than a triggering role. The hydrophilic nature and micro-/nano-scale surface features of the mesh reduce the nucleation energy barrier and promote heterogeneous nucleation once the thermal condition for condensation is met. In other words, surface energy affects where and how efficiently condensation occurs, but it does not cause condensation in the absence of sub-dew-point temperatures. The surface does not induce vapor capture at temperatures above the dew point and does not function as a hygroscopic or adsorptive medium.

No electrostatic, electrowetting, ionization, or charged-surface mechanism is used to trigger condensation. The device does not apply electric fields to polarize water molecules, alter vapor trajectories, or induce electro-condensation. Any electric power supplied to the system is used solely to operate the thermoelectric cooling unit (110) and the associated control electronics (160), not to directly manipulate vapor-phase behavior.

Accordingly, for purposes of specification and claim interpretation, condensation in the device is thermally triggered by active cooling below the dew point, with surface energy engineered solely to enhance nucleation, coalescence, and drainage, and with no electrostatic triggering mechanism. This places the device squarely within the class of cooling-based atmospheric condensation systems. Back-diffusion of moisture is prevented by a combination of laminar flow directionality, axial humidity stratification, geometric flow impedance, and localized condensation sinks.

Ambient air enters the pen housing (100) through the airflow channels (130) and proceeds in a defined axial direction toward and through the condensation chamber (125). During operation, the thermoelectric cooling unit (110) maintains the hydrophilic condensation mesh (120) below the dew point of the incoming air, thereby continuously removing water vapor from the air stream by phase-change condensation. This creates a local vapor sink at the condensation surface, which establishes a vapor concentration gradient directed toward the mesh. Because vapor is consumed at the cold surface, the local vapor partial pressure adjacent to the mesh remains lower than that of upstream air, suppressing reverse diffusion.

The airflow regime within the pen remains laminar and low-Reynolds-number, as previously described, which minimizes axial and transverse mixing. In laminar flow, molecular diffusion is dominated by the imposed concentration gradient rather than by turbulent transport. As a result, the axial humidity stratification that develops along the length of the pen-high humidity upstream and progressively lower humidity downstream-acts as a one-way vapor gradient. Any tendency for vapor to diffuse upstream is countered by the fact that upstream regions already possess a higher vapor concentration and are continually replenished by incoming ambient air.

Geometric features further inhibit back-diffusion. The airflow channels (130), including any micro-baffles (132), helical duct sections (134), or Venturi sections (136), introduce distributed flow resistance that favors forward convective transport over diffusive backflow. These structures increase the effective path length and reduce cross-sectional diffusion area without inducing turbulent recirculation, thereby biasing mass transport in the downstream direction. Additionally, the condensation mesh (120) itself functions as a porous diffusion barrier, in which vapor transport toward the upstream side is continually offset by ongoing condensation within the mesh structure.

Thermal effects also contribute to back-diffusion suppression. Upstream regions of the condensation chamber (125) are maintained at lower temperatures than downstream regions due to stronger thermal coupling to the cold junction of the thermoelectric cooling unit (110). Because saturated vapor pressure decreases with temperature, this axial thermal gradient reinforces the vapor concentration gradient, making upstream diffusion thermodynamically unfavorable. Finally, any condensed liquid is rapidly removed from the capture interface by capillary-driven transport and drainage toward the micro water reservoir (150). This prevents re-evaporation of collected water into upstream air volumes, which could otherwise act as a source of back-diffusing vapor. The engineered hydrophilic-hydrophobic boundary layers described previously further ensure that liquid water is displaced away from the condensation interface rather than retained in regions where it could re-enter the vapor phase.

Accordingly, the back-diffusion of moisture within the pen-shaped device is prevented by the continuous removal of water vapor at a sub-dew-point condensation surface, the maintenance of laminar, directionally biased airflow, the establishment of axial humidity and temperature gradients, and the rapid drainage of condensed liquid.

FIG. 12 illustrates a flow chart for a method for generating water from an ambient humid air in accordance with an embodiment of the present disclosure. The method 1200 includes
Step 1202 discloses about initiating, by a microcontroller unit, one or more humidity and temperature sensors (140) to detect ambient environmental conditions, wherein one or more humidity and temperature sensors (140) communicatively coupled to the microcontroller unit, wherein the one or more humidity and temperature sensors (140) are positioned within and adjacent to airflow channels (130);
Step 1204 discloses about providing, by one or more humidity and temperature sensors (140), environmental data signals to the microcontroller unit (MCU) (160) when the ambient air is humid air;
Step 1206 discloses about receiving, by a plurality of airflow channels (130), and directing the ambient humid air inside the pen housing (100);
Step 1208 discloses about providing, by a thermoelectric cooling unit (110), a cooled condensation surface, wherein the Thermoelectric cooling unit (110) is positioned within the pen housing (100) and positioned adjacent to a hydrophilic condensation mesh (120);
Step 1210 discloses about capturing and condensing, by the hydrophilic condensation mesh (120) thermally coupled to the Thermoelectric cooling unit, the ambient humid air, wherein the Thermoelectric cooling unit (110) cools the ambient humid air below its dew point and condense onto the hydrophilic condensation mesh (120); and
Step 1212 discloses about collecting, by a micro water reservoir (150), collecting condensed water, wherein the micro water reservoir (150) is positioned below the hydrophilic condensation mesh (120) and fluidly connected to the hydrophilic condensation mesh (120).

### Advantages of the Invention

1. Miniaturized design enables atmospheric water generation in a handheld device.
2. Dual-use configuration integrates writing and environmental sensing.
3. Energy-efficient thermoelectric condensation with automatic control logic.
4. Closed-loop design ensures hygiene and prevents leakage.
5. Rechargeable system for repeated use without an external apparatus.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of methods described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible.

1. A pen shaped handheld apparatus for generating a water from an ambient humid air, said apparatus comprising:
a pen housing;
a plurality of airflow channels configured to receive and direct the ambient humid air inside the pen housing;
a thermoelectric cooling unit positioned within the pen housing and positioned adjacent to a hydrophilic condensation mesh to establish a cooled condensation surface;
a condensation chamber, comprising the hydrophilic condensation mesh thermally coupled to the thermoelectric cooling unit for capturing and condensing the ambient humid air, wherein the thermoelectric cooling unit cools the ambient humid air below its dew point and condense onto the hydrophilic condensation mesh;
a one or more humidity and temperature sensors communicatively coupled to a microcontroller unit, wherein the one or more humidity and temperature sensors are positioned within and adjacent to the airflow channels and are configured to detect ambient environmental conditions prior to activation of the thermoelectric cooling unit;
a microcontroller unit (MCU) configured to control an operation of the thermoelectric cooling unit based on inputs of the one or more humidity and temperature sensors, wherein the MCU is configured to receive environmental data signals from the one or more humidity and temperature sensors for detecting ambient humidity and temperature;
a micro water reservoir positioned below the hydrophilic condensation mesh and fluidly connected to the hydrophilic condensation mesh for collecting condensed water; and
a rechargeable lithium battery electrically coupled to the MCU and thermoelectric cooling unit to provide portable power, wherein the microcontroller unit is configured to dynamically adjust an electrical power supplied to the thermoelectric cooling unit in response to changes in sensed ambient humidity and temperature such that a difference between a vapor density of incoming air and a saturation vapor density at the hydrophilic condensation mesh remains within a predefined operating range; wherein the thermoelectric cooling unit is configured to extract heat from the hydrophilic condensation mesh at a rate corresponding to a latent heat of condensation associated with water vapor transitioning from a gaseous phase to a liquid phase at the cooled condensation surface of the hydrophilic condensation mesh, such that a temperature of the hydrophilic condensation mesh remains substantially constant during continuous condensation; and wherein the airflow channels are configured such that a velocity of airflow produces a convective heat transfer coefficient that, in combination with conductive heat removal through the thermoelectric cooling unit, maintains a stable temperature gradient across the hydrophilic condensation mesh during operation; and
wherein the hydrophilic condensation mesh is configured such that condensation occurs under a diffusion-limited regime in which a rate of water vapor transport toward the cooled condensation surface of the hydrophilic condensation mesh is governed by a concentration gradient established between bulk airflow and a boundary layer adjacent to the hydrophilic condensation mesh; wherein the microcontroller unit is configured to control operation of the thermoelectric cooling unit based on a calculated difference between an enthalpy of incoming air and an enthalpy of air at the hydrophilic condensation mesh, such that energy removal corresponds to a combined sensible and latent heat reduction required for condensation; and wherein the thermoelectric cooling unit and the hydrophilic condensation mesh are configured such that a local heat flux from the hydrophilic condensation mesh to the thermoelectric cooling unit is proportional to a temperature difference between the cooled condensation surface of the hydrophilic condensation mesh and a cold junction of the thermoelectric cooling unit, and wherein the local heat flux corresponds to heat released during condensation of water vapor.

2. The pen shaped handheld apparatus of claim 1, further comprising:
a plurality of venturi sections incorporated into an airflow channels upstream or downstream of the hydrophilic condensation mesh, wherein the plurality of venturi sections comprise a converging cone and a diverging cone, configured to increase velocity of the air and decrease a static pressure of the air, wherein a static pressure reduction configured to draw ambient air through a condensation chamber and maintain a consistent airflow rate under natural convection conditions; and
a localized cold junction formed at an interface between the thermoelectric cooling unit and the hydrophilic condensation mesh, wherein when the thermoelectric cooling unit is energized, a temperature gradient is established between the cold junction adjacent to the hydrophilic condensation mesh and a surrounding ambient air flowing through the airflow channels, configured to produce a temperature differential of approximately 10° C. to 25° C. relative to the ambient humid air, thereby cooling the air in contact with the cooled condensation surface below its dew point and inducing condensation of atmospheric moisture.

3. The pen shaped handheld apparatus of claim 1, wherein a localized cold junction causes the air stream to undergo sensible cooling as it approaches a cold capture surface, dew-point crossing at a mesh-adjacent boundary layer and latent heat rejection as water vapor condenses on a hydrophilic surface, wherein the stable temperature gradient is spatially localized within the condensation chamber and is intentionally maintained to depress an air temperature below its dew point at a capture surface, wherein the hydrophilic condensation mesh is thermally coupled to a cold side of the thermoelectric cooling unit and simultaneously exposed to warmer, humid airflow, a continuous transverse temperature gradient exists across capture surfaces during operation; and wherein the airflow channels include micro-fans or passive vents to optimize a volume of air exposed to the cooled condensation surface, wherein the airflow channels is configured to receive ambient air and expose the ambient air to a cold surface generated by the thermoelectric cooling unit, wherein when the air temperature is reduced below its saturation temperature at a predefined humidity ratio, water vapor condenses on the hydrophilic condensation mesh.

4. The pen shaped handheld apparatus of claim 1, wherein the thermoelectric cooling unit is configured to actively lower a temperature of the ambient air below its dew point and provide a water vapor to undergo a gas-to-liquid phase change directly on a cooled surface, and wherein the micro water reservoir includes a removable cap and a micro-filter for hygienic storage and retrieval of condensed water.

5. The pen shaped handheld apparatus of claim 1, wherein the microcontroller unit is configured to execute a closed-loop thermal regulation sequence by continuously acquiring analog or digital signals corresponding to ambient humidity and ambient temperature from the one or more humidity and temperature sensors, converting acquired analog or digital signals into calibrated environmental parameters, determining a corresponding dew point temperature based on the calibrated environmental parameters, and generating a control signal that modulates an electrical input supplied from the rechargeable lithium battery to the thermoelectric cooling unit, wherein the control signal is iteratively updated at a predefined sampling frequency such that a cold-side surface temperature of the thermoelectric cooling unit, thermally coupled to the hydrophilic condensation mesh, is maintained below a determined dew point temperature during operation.

6. The pen shaped handheld apparatus of claim 1, wherein the thermoelectric cooling unit is positioned in direct thermal contact with the hydrophilic condensation mesh such that a conductive heat transfer path is established between a cold junction of the thermoelectric cooling unit and the hydrophilic condensation mesh, wherein energization of the thermoelectric cooling unit produces a temperature gradient extending from the cold junction toward ambient air flowing through the airflow channels, and wherein the temperature gradient is spatially confined within the condensation chamber such that a boundary layer of air adjacent to the hydrophilic condensation mesh is reduced below a saturation temperature corresponding to the ambient humidity detected by the one or more humidity and temperature sensors; and wherein the plurality of airflow channels are dimensioned and arranged to guide ambient humid air along a defined flow path over and through the hydrophilic condensation mesh, and wherein the airflow channels are configured to impose a low-Reynolds-number flow regime such that a laminar boundary layer is formed adjacent to the hydrophilic condensation mesh, and wherein the laminar boundary layer establishes a controlled diffusion gradient of water vapor from a bulk air stream toward the cooled condensation surface of the hydrophilic condensation mesh, resulting in continuous mass transfer of water vapor toward a condensation interface under steady-state flow conditions.

7. The pen shaped handheld apparatus of claim 1, wherein the hydrophilic condensation mesh comprises a surface structure having a distributed pore network and surface roughness features configured to induce heterogeneous nucleation of water droplets when a surface temperature is maintained below the dew point, and wherein the hydrophilic condensation mesh is further configured to support droplet coalescence through capillary interaction between adjacent nucleation sites, and wherein the coalesced droplets migrate along the surface structure of the hydrophilic condensation mesh under capillary and gravitational forces toward a lower region of the condensation chamber that is fluidly connected to the micro water reservoir; and wherein the micro water reservoir is positioned relative to the hydrophilic condensation mesh such that condensed liquid water formed on the hydrophilic condensation mesh is directed into the micro water reservoir through a continuous liquid transport path defined by the surface structure of the hydrophilic condensation mesh, and wherein the continuous liquid transport path is maintained by a capillary pressure gradient generated by variations in effective pore size and wettability along the hydrophilic condensation mesh, such that liquid accumulation at the condensation interface is reduced during continuous condensation operation.

8. The pen shaped handheld apparatus of claim 1, wherein the microcontroller unit is configured to control an activation state of the thermoelectric cooling unit based on a comparison between a detected ambient humidity level and a predefined humidity threshold, and wherein the thermoelectric cooling unit is energized only when the detected ambient humidity level exceeds the predefined humidity threshold, and wherein the microcontroller unit further regulates a duration of energization based on a difference between a detected ambient temperature and a calculated dew point temperature to maintain a sustained temperature differential at the hydrophilic condensation mesh.

9. The pen shaped handheld apparatus of claim 1, wherein the thermoelectric cooling unit is configured to transfer heat from the hydrophilic condensation mesh to an opposing side of the thermoelectric cooling unit through a solid-state heat pumping mechanism, and wherein latent heat released during condensation of water vapor on the hydrophilic condensation mesh is conducted into the thermoelectric cooling unit and transported away from the condensation chamber, such that a temperature rise at the hydrophilic condensation mesh is limited during continuous condensation; and wherein the airflow channels are arranged to introduce ambient air into the condensation chamber along a longitudinal direction of the pen housing, and wherein the airflow channels are configured such that a velocity of the ambient air is maintained within a predefined low velocity range to increase a residence time of the ambient air adjacent to the hydrophilic condensation mesh, and wherein an increased residence time promotes diffusion-driven transport of water vapor toward the cooled condensation surface of the hydrophilic condensation mesh.

10. The pen shaped handheld apparatus of claim 1, wherein the one or more humidity and temperature sensors are positioned within and adjacent to the airflow channels such that environmental measurements are obtained upstream of the condensation chamber, and wherein the microcontroller unit (MCU) utilizes upstream environmental measurements to predict a thermodynamic state of the ambient air prior to entry into the condensation chamber, and adjusts an electrical input to the thermoelectric cooling unit in accordance with a predicted thermodynamic state; and wherein the hydrophilic condensation mesh is configured to maintain a continuous exposure of cooled surface area to the ambient air by promoting removal of condensed liquid through a combination of capillary-driven transport and gravitational drainage, and wherein accumulation of liquid on the hydrophilic condensation mesh is limited such that a thermal resistance at an interface between the ambient air and the hydrophilic condensation mesh remains within a range that supports continuous heat transfer during condensation.

11. The pen shaped handheld apparatus of claim 1, wherein the thermoelectric cooling unit, the hydrophilic condensation mesh, and the airflow channels are arranged within the condensation chamber such that a localized temperature gradient is established between a cooled surface region of the hydrophilic condensation mesh and a bulk air stream within the airflow channels, and wherein the localized temperature gradient induces a continuous diffusion flux of water vapor toward the cooled surface region, resulting in steady-state condensation under continuous airflow conditions; and wherein the microcontroller unit is configured to compute a dew point temperature corresponding to sensed ambient humidity and temperature values and to continuously update a target cooling setpoint defined as a fixed temperature offset below a computed dew point, and wherein the microcontroller unit modulates an electrical current supplied to the thermoelectric cooling unit in accordance with a deviation between the target cooling setpoint and an inferred surface temperature of the hydrophilic condensation mesh such that the inferred surface temperature remains within a bounded sub-dew-point range during steady-state operation.

12. The pen shaped handheld apparatus of claim 1, wherein the thermoelectric cooling unit is operated under a controlled transient regime in which an initial high-current activation phase is applied to rapidly establish a sub-dew-point condition at the hydrophilic condensation mesh, followed by a reduced-current maintenance phase governed by the microcontroller unit, wherein the transition between the initial high-current activation phase and the reduced-current maintenance phase is determined based on a rate of change of sensed ambient temperature and humidity signals; and wherein the airflow channels and the hydrophilic condensation mesh are arranged such that a vapor depletion region is formed adjacent to the hydrophilic condensation mesh during operation, and wherein continuous condensation at the hydrophilic condensation mesh establishes a localized reduction in vapor partial pressure that produces a sustained diffusion gradient from upstream regions of the airflow channels toward the condensation chamber.

13. The pen shaped handheld apparatus of claim 1, wherein the hydrophilic condensation mesh is configured to generate a non-uniform temperature field across its surface due to differential thermal coupling with the thermoelectric cooling unit, and wherein the non-uniform temperature field establishes spatially distributed condensation zones including a primary nucleation region and a secondary coalescence region, such that initial droplet formation occurs at colder regions and droplet growth and transport occur at relatively warmer adjacent regions; and wherein the hydrophilic condensation mesh is configured to maintain a continuous liquid transport pathway by establishing a capillary pressure gradient along a thickness and surface of the hydrophilic condensation mesh, wherein smaller effective pore regions located proximate to a thermoelectric cold junction retain condensed liquid during initial nucleation and larger effective pore regions located downstream release liquid toward the micro water reservoir upon exceeding a capillary breakthrough condition.

14. The pen shaped handheld apparatus of claim 1, wherein the thermoelectric cooling unit and the hydrophilic condensation mesh are operated such that a condensation mass flux at the hydrophilic condensation mesh is governed by a vapor density gradient between ambient air flowing through the airflow channels and a saturated vapor condition at the cooled condensation surface of the hydrophilic condensation mesh, and wherein the microcontroller unit regulates an electrical input to the thermoelectric cooling unit such that the vapor density gradient is maintained at a non-zero value during operation; and wherein a condensation process occurring at the hydrophilic condensation mesh is characterized by a coupled heat and mass transfer condition in which a rate of latent heat release associated with condensation of water vapor is balanced by a rate of heat removal through the thermoelectric cooling unit, and wherein the microcontroller unit controls the thermoelectric cooling unit to maintain the balance between latent heat generation and conductive heat removal across a thermoelectric junction.

15. The pen shaped handheld apparatus of claim 1, wherein the hydrophilic condensation mesh and the airflow channels are configured such that a local condensation mass flux is proportional to a difference between an ambient vapor density and a saturation vapor density corresponding to a surface temperature of the hydrophilic condensation mesh, and wherein the surface temperature is actively regulated by the thermoelectric cooling unit under control of the microcontroller unit to sustain continuous condensation; and wherein the microcontroller unit is configured to regulate operation of the thermoelectric cooling unit such that a temperature of the hydrophilic condensation mesh is maintained at a level that produces a vapor pressure at the cooled condensation surface of the condensation mesh lower than a vapor pressure of incoming ambient air, thereby establishing a continuous vapor diffusion flux toward the cooled condensation surface.

16. The pen shaped handheld apparatus of claim 1, wherein the airflow channels and the hydrophilic condensation mesh are configured such that a boundary layer, adjacent to the hydrophilic condensation mesh, exhibits simultaneous gradients of temperature and vapor concentration, and wherein the stable temperature gradient induces sensible cooling of the air and a vapor concentration gradient induces diffusive transport of water vapor toward the hydrophilic condensation mesh within a same spatial region.

17. The pen shaped handheld apparatus of claim 1, wherein the thermoelectric cooling unit is controlled such that a temperature difference between a cold side and ambient air is maintained within a range that produces a condensation mass flux sufficient to sustain droplet formation while preventing a transition to frost formation at the hydrophilic condensation mesh, and wherein the hydrophilic condensation mesh is configured such that a thickness and pore structure of the hydrophilic condensation mesh establish a resistance to vapor diffusion that, in combination with airflow velocity within the airflow channels, produces a controlled mass transfer coefficient governing condensation rate at the cooled condensation surface of the condensation mesh; and wherein the airflow channels and the hydrophilic condensation mesh are configured such that a Peclet number associated with airflow and vapor diffusion remains within a range that supports diffusion-dominated mass transfer toward the cooled condensation surface; wherein the microcontroller unit is configured to regulate operation of the thermoelectric cooling unit such that a ratio of heat removed by the thermoelectric cooling unit to a mass of condensed water remains within a range corresponding to a latent heat of vaporization of water under ambient conditions.

18. The pen shaped handheld apparatus of claim 1, wherein the thermoelectric cooling unit is arranged relative to the hydrophilic condensation mesh such that a non-uniform thermal coupling is established across a thickness and lateral extent of the hydrophilic condensation mesh, wherein regions of the hydrophilic condensation mesh in direct proximity to a cold junction of the thermoelectric cooling unit are maintained at a lower temperature relative to regions exposed to incoming airflow within the airflow channels, and wherein the non-uniform thermal coupling produces a spatial temperature gradient across the hydrophilic condensation mesh that induces preferential nucleation of water droplets at colder regions and directional migration of condensed liquid toward relatively warmer regions in fluid communication with the micro water reservoir; and wherein the thermoelectric cooling unit (110) is configured to operate based on a Peltier effect in which an electrical current passing through a junction of dissimilar conductive materials produces heat absorption at the hydrophilic condensation mesh (120) and heat rejection at an opposing region of the thermoelectric cooling unit (110), and wherein the microcontroller unit (160) regulates a magnitude of the electrical current to control a rate of heat absorption at the hydrophilic condensation mesh (120).

19. The pen shaped apparatus of claim 1, wherein the plurality of airflow channels are geometrically configured relative to the condensation chamber such that ambient air is guided along a flow path that sequentially exposes the air to progressively decreasing surface temperatures along the hydrophilic condensation mesh, wherein an upstream portion of the hydrophilic condensation mesh initiates partial sensible cooling of the air without full condensation and a downstream portion of the hydrophilic condensation mesh, maintained at a lower temperature by the thermoelectric cooling unit, induces a dew-point crossing within a boundary layer adjacent to the hydrophilic condensation mesh, resulting in staged condensation along the flow path; and wherein the hydrophilic condensation mesh, the thermoelectric cooling unit, and the airflow channels are arranged within the condensation chamber such that a coupled thermo-capillary transport condition is established, wherein condensation-induced liquid formation at the hydrophilic condensation mesh produces a local capillary pressure field governed by pore-scale curvature of the hydrophilic condensation mesh, and wherein the local capillary pressure field drives liquid transport away from a condensation interface toward the micro water reservoir while simultaneously maintaining an exposed cold surface for continued vapor diffusion, such that condensation, heat removal, and liquid transport occur concurrently within the condensation chamber.
